(19) United States
(12) Patent Application Publication
(10) Pub. No.: US 2009/0113203 A1
(43) Pub. Date: Apr. 30, 2009

(54) Network System

(75) Inventors: Munetoshi Tsuge, Fujisawa (JP); Kazuyoshi Hoshino, Tokyo (JP); Tadashi Kaji, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Ltd.

(21) Appl. No.: 12/255,788

(22) Filed: Oct. 22, 2008

(30) Foreign Application Priority Data
Oct. 26, 2007 (JP) 2007-278305

(51) Int. Cl. H04L 9/00; H04L 29/06

(52) U.S. Cl. 713/151

(57) ABSTRACT

An encryption communication module on the side of a service providing server reports a global IP address allocated to an NAPT router on the service providing server side and a port number of an outside UDP header used on the global side to an authentication/key exchange server. When receiving an encryption packet from an encryption communication module on the user terminal side, the encryption communication module on the service providing server side overwrite a source/destination IP address of an inside IP header by a source/destination IP address of an outside IP header. The encryption communication module further changes a source port number of an inside TCP•UDP header to a unique value for each communication session in the encryption communication having the same source IP address in the outside IP header. The inverse header change is made when the packet is transmitted to the encryption communication module of the user terminal side.

### INCORPORATION BY REFERENCE

The present application claims priority from Japanese application JP2007-278305 filed on Oct. 26, 2007, the content of which is hereby incorporated by reference into this application.

### BACKGROUND OF THE INVENTION

1. Field of the Invention

In a system in which a client and a first server exchange key information through a second server trusted by both of the parties and execute encryption tunneling communication by using the key, this invention relates to a method that makes it possible to carry out communication even when a network/address translation apparatus exists on a communication line between the client and the first server.

2. Description of the Related Art

Encryption of communication has been carried out daily in an IP (Internet Protocol) network such as the Internet as a method for protecting the communication content from a threat of security typified by tapping on the communication line. Typical examples of various kinds of encryption communication protocols include IPsec (IP Security Protocol) as an encryption communication protocol of network layers in OSI (Open Systems Interconnection) reference model and TLS (Transport Layer Security) as an encryption communication protocol of transport layers.

Generally, two steps of (1) authentication of the other side of communication and (2) sharing of key information used for encryption and authentication of communication data with the other side communication are necessary before starting communication in encryption communication. In encryption communication by TLS, for example, the step (1) is attained as one of the communication hosts receives a public key certificate of the other side and confirms the public key certificate by using a preconfigured root certificate whether or not the public key certificate is issued by a reliable certification authority. The step (2) is conducted as one of the communication hosts encrypts a common key it creates by itself by using the public key contained in the public key certificate received from the other side and sends it to the other side. When both communication hosts can share the common key, encryption communication by the common key cipher and communication data authentication by HMAC (Keyed-Hashing for Message Authentication Code) can be conducted.

In encryption communication by IPsec, it is ordinary to conduct the steps (1) and (2) by using a key exchange protocol called “IKE (Internet Key Exchange)”. In other words, the step (1) and establishment of the encryption communication line for executing the step (2) are conducted by using a protocol called “ISAKMP (Internet Security Association Key Management Protocol)” and the step (2) is then conducted by using the encryption communication line.

JP-B2-3859667 (corresponding to US 2006/0095768A1, Hoshino et al.) discloses a method for conducting the steps (1) and (2) in IPsec encryption communication by using a server (hereinafter called “authentication/key exchange server”) intermediating authentication and key exchange of both communication hosts. According to the method of this patent document 1, both communication hosts operating as UA (User Agent) of SIP (Session Initiation Protocol) conduct the step (1) and establishment of the encryption communication line for executing (2) by using SIPS (Secure SIP) that is SIP encrypted by TLS to establish connection to an authentication/key exchange server operating as an SIP server. Sharing of the key information of the step (2) is conducted by using this encryption communication line through the authentication/key exchange server.

On the other hand, when an internal network owned by users (hereinafter called “LAN (Local Area Network)”) is connected to an external network (hereinafter called also “WAN (Wide Area Network)”) such as the Internet, translation of an IP address and TCP (Transmission Control Protocol)/UDP (User Datagram Protocol) port called “NAPT (Network Address Port Translation”) is conducted in many cases between both hosts. When NAPT is conducted, one IP address on the WAN side can be shared by a plurality of hosts on the LAN side. For this reason, NAPT has gained a wide application as effective means for connecting a large number of user hosts to the Internet while the number of allocations of IPv4 (IP Version 4) addresses in the Internet is restricted.

NAPT is generally mounted in many cases as one of the functions of communication equipment such as a router or a firewall deployed at the boundary between LAN and WAN. The communication equipment having NAPT mounted thereto will be hereinafter called altogether an “NAPT router”. Generally, only one global IP address that can be used for communication in the whole Internet is allocated either manually or automatically to the WAN side interface of the NAPT router. A private IP address the use of which is permitted only inside the LAN is generally used on the LAN side of the NAPT router.

Incidentally, NAPT is called in some cases “NAT (Network Address Translation)”, too. The term “NAT” has a narrow meaning and a broad meaning. The term in the narrow meaning indicates those which translate only the IP address without executing translation of TCP•UDP ports. In the broad sense, the term indicates both NAPT and NAPT in the narrow meaning of the term. Since NAPT has a greater number of fields of utilization than NAPT in the narrow meaning, NAT in the broad sense is used substantially equivalently as NAPT. To avoid confusion, the term “NAPT” will be used basically in this specification instead of “NAT”.

When encryption communication is to be carried out by IPsec in the communication line through the NAPT router, it is generally known that communication cannot be made with ordinary IPsec packets as they are. Though several causes exist, one of the causes is that a TCP•UDP header that is not encrypted is not added to the IPsec packet. In other words, the form of the IPsec packet includes two kinds, i.e. a transport mode (form that encrypts payload part of IP packet before encryption) and a tunnel mode (form that encrypts entire IP packet before encryption and adds afresh an IP header). Since the TCP•UDP header (contained in payload part of IP packet) is encrypted in the packets of either form, port translation in the NAPT router does not function and this for does not eventually exceed the NAPT router.

JP-B2-3793083 (corresponding to U.S. Pat. No. 6,957,346B1, Kivinen et al.) discloses a method for avoiding this problem. The communication method described in this second patent document checks whether or not an NAPT router exists on the communication line and when it exists, inserts afresh a UDP header to a part immediately after a leading IP header when an IPsec packet of the transport mode form is generated. The problem can be avoided in the case of the IPsec packet of the tunnel mode form, too, by additionally inserting a new UDP header immediately after the IP header added to the leading part in the same way as in the method of the patent document 2.

### SUMMARY OF THE INVENTION

As described above, to authenticate the other side of communication and to share key information, the encryption communication method by IPsec includes a method that uses IKE and the method that uses the authentication/key exchange server described in the patent document 1. The form of the IPsec encryption communication packet includes two kinds, that is, the transport mode form and the tunnel mode form, and the UDP header can be added in either form. The description will be given hereinafter on the case where authentication of the other side of communication and sharing of the key information are executed by using the authentication/key exchange server, and the tunnel mode form having the UDP header added is used for the IPsec packet form.

On the premise described above, NAPT operates for the IPsec packet in the NAPT router but IPsec communication through the NAPT router is not always possible by this arrangement alone. The positions of installation of the NAPT routers may be two positions, that is, at a boundary between LAN and WAN (NAPT router 130-C in the network construction shown in FIG. 1) on the side of a communication host (hereinafter called “user terminal”) on which an application client operates as a communication starting request side and at a boundary between LAN and WAN (NAPT router 130-S in the network construction shown in FIG. 1) on the side of a communication host on which an application server receiving the communication starting request (hereinafter called “service providing server”) operates. Nonetheless, IPsec communication through the NAPT routers cannot be carried out correctly owing to the following problems occurring depending on the installation positions of the routers.

The following two problems occur in IPsec communication through the NAPT router when the NAPT router exists on the user terminal side.

(A) Since the user terminal recognizes the IP address of its own by the private IP address inside LAN(IP address A in FIG. 1), the private IP address is set to an IP address field on the user terminal side of an inside IP header of the IP sec tunnel mode form packet (source (Src) IP address 2111 in FIG. 21 in the case of packet sent by user terminal), too. IP address translation is not made by NAPT because the inside IP header passes through the NAPT router under the state where it is encrypted but reaches the service providing server while the private IP address of the user terminal is stored. However, the private IP address of the user terminal is the one that is allocated under management different from LAN on the service providing server side and there is the possibility that the service providing server fails to correctly recognize the route to the private IP address. Moreover, there is another possibility that hosts existing inside LAN on the service providing server side and LAN on other user terminal side (LAN deployed under NAPT router different from user terminal of packet source) overlap with the IP address.

(B) As one of the methods of solving the problem (A) described above, it may be possible to replace the user terminal side IP address contained in the inside header of the IPsec tunnel model form packet in the service providing server by the global IP address allocated to the NAPT router on the user terminal side and to interpret the packet. Owing to this measure, the service providing server can correctly recognize the route to the user terminal side IP address. In addition, the possibility of overlap of the IP address with hosts existing inside the service providing server side LAN and other user terminal side LAN can be eliminated. On the other hand, when two user terminals existing inside LAN under the same NAPT router communicate with the same service providing server for user terminal side port number field of the inside TCP/UDP header of the IPsec tunnel mode form packet (source port number 2121 in FIG. 21 in the case of packet sent by user terminal) by using the same port number, the service providing server cannot know from which user terminal the received packet is sent.

When the NAPT router exists on the service providing server side, the following two problems occur in the IPsec communication through this NAPT router.

(C) Since the service providing server recognizes the IP address of its own by the private IP address inside LAN (IP address E in FIG. 1), the service providing server reports its private IP address but not the global IP address allocated to the service providing server side NAPT router (IP address D in FIG. 1) when it registers its own IP address to the authentication/key exchange server or when it reports its own IP address to the user terminal. As for the service providing server side port number used for the outside UDP header of the IPsec tunnel mode form packet, too, the value on the LAN side is reported to the user terminal when the value on the WAN side is different from the value on the LAN side (UDP port numbers d-udp and e-udp in FIG. 1) in the translation rule of the NAPT router on the service providing server side. As a result, though the user terminal uses these private IP address and LAN side UDP port number for the construction of the outside header of the IPsec tunnel mode form packet, the packet does not reach the service providing server. When SIP is used for the communication starting request protocol from the user terminal to the service providing server, the user terminal must know URI (Uniform Resource Identifier) corresponding to the service providing server to construct the communication starting request message. However, when registration of the IP address of the service providing server to the authentication/key exchange server is made by the private IP address, the desired URI cannot be obtained even when the URI is inquired to the authentication/key exchange server on the basis of the destination (dst) IP address (global IP address) sent by the application of the user terminal by using the method such as the AOR (Address-of-Record) method described in the afore-mentioned patent document 1.

(D) It will be assumed hereby that the problem (C) is solved and the global IP address (IP address D in FIG. 1) and the WAN side port number (d-udp in FIG. 1) are changed so that they can be reported as the IP address of the service providing server and the service providing server side port number of the outside UDP header to the user terminal and the authentication/key exchange server. In this case, the service providing server side IP address field of the inside IP header of the IPsec tunnel mode form packet (destination IP address 2112 in FIG. 21 in the case of packet sent by user terminal) stores the global IP address, too. However, since this inside IP header passes through the NAPT router under the encrypted state, IP address translation by NAPT is not executed and the global IP address of the service providing server reaches the service providing server while the global IP address of the service providing server is stored. However, the service providing server does not recognize this global IP address as the IP address allocated to itself and there remains the possibility that the IP processing of the service providing server cannot correctly process the packet.

In the environment in which the NAPT router exists on the communication line between the user terminal and the service providing server, this invention is directed by solving the problems (A), (B), (C) and (D) described above to allow both hosts to conduct mutual authentication and sharing of key information and to conduct encryption communication by the IPsec tunnel mode form packet having the UDP header that is added by using the key information.

To solve the problems (A), (B), (C) and (D), the communication method according to the invention executes the following processing (a), (b), (c), (d) and (e).

(a) To solve the problem (C), the global IP address allocated to the NAPT router on the service providing server side and the WAN side port number of the outside UDP header are registered in advance to the encryption communication processing inside the service providing server. This registration may be made either manually by a manager of the service providing server side or setting may be made automatically and synchronously with the NAPT router. When the IP address of its own and the port number of the outside UDP header are sent to the authentication/key exchange server and the user terminal, these IP address and port number registered in advance are used.

(b) To solve the problems (A) and (D) when the IPsec tunnel mode form packet is sent from the user terminal to the service providing server, a decapsulation processing inside the encryption communication processing in the service providing server decrypts the encrypted part (encrypted packet data 2240 in FIG. 22) and then overwrites a source IP address field (source IP address 2111 in FIG. 21) and a destination IP address field (destination IP address 2112 in FIG. 21) of the inside IP header contained in the decrypted data by values of a source IP address field (source IP address 2211 in FIG. 22) and a destination IP address field (destination IP address 2212 in FIG. 22) of the outside IP header.

(c) To solve the problem (B) encountered when the IPsec tunnel mode form packet is sent from the user terminal to the service providing server, the decapsulation processing in the encryption communication processing inside the service providing server decrypts the encrypted part of the packet (encrypted packet data 2240 in FIG. 22) and then changes the value of the source port number field of the inside TCP•UDP header contained in the decrypted data (source port number 2121 in FIG. 21) to a value which becomes unique to each SPI (Security Parameter Index) for all the communications having the same user terminal side IP address of the outside IP header. (If the unique value is not allocated, the value is allocated afresh).

(d) To solve the problems (A), (B) and (D) encountered when the IPsec tunnel mode form packet is sent from the service providing server to the user terminal, the decapsulation processing in the encryption communication processing inside the service providing server stores the port number decided in (c) in the table. This processing also stores other outside header information (source/destination IP addresses and source/destination UDP port numbers) and the inside header information (source/destination IP address, protocol number and source/destination port numbers of TCP•UDP) in the table on the basis of the IPsec tunnel mode form packet received from the user terminal or the information acquired from the communication starting request message sent to and received from the user terminal through the authentication/key exchange server. When receiving the inside packet to be sent from the application inside the service providing server to the user terminal, the encapsulation processing in the encryption processing inside the service providing server compares source/destination IP address of the packet with the corresponding column of the outside header information of the table storing the source/destination IP address, compares source port number of the packet with the corresponding column of the inside header information storing the source port number, and compares destination port number of the packet with the column of the port number decided in (c) and stored in the table. The inside header of the packet is rewritten on the basis of the inside header information of the entry in which all of them are coincident and the outside header of the packet is created on the basis of the outside header information of this entry.

(e) When the IP header and the TCP•UDP header of the packet are rewritten as a result of the execution of the processing (b), (c) and (d), the IP header checksum and the TCP•UDP header checksum of the packet are appropriately calculated again and the value of the calculation is set once again to the corresponding field inside the header of the packet.

When the communication method of the invention is used in the manner described above, the user terminal and the service providing server can execute mutual authentication and key sharing by using the authentication/key exchange server in the environment in which the NAPT router exists on the communication line between the user terminal and the service providing server and can conduct encryption communication in the IPsec tunnel mode form packet having the UDP added by using the key information. In this instance, the NAPT router may exist on only the user terminal side or the service providing server side or on both sides.

The communication method of the invention must be applied to the encryption communication processing on the service providing server side but need not be applied to the encryption communication processing on the user terminal side. Therefore, the communication method of the invention can execute the encryption communication through the NAPT router for all the user terminals without any problem in the environment in which the user terminals to which the present method is applied and those to which the method is not applied exist in mixture, too. Furthermore, no change is necessary at all for communication equipment other than the encryption communication processing and software.

In addition, the communication method of the invention does not need to judge whether or not the NAPT router exists on the communication line with the exception of the case where the service providing server dynamically acquires the global IP address of its own as well as the WAN side port number of the outside UDP header from the NAPT router. Therefore, the processing algorithm can be prevented from getting much more complex owing to the addition of the communication method of the invention to minimum.

Other objects, features and advantages of the invention will become apparent from the following description of the embodiments of the invention taken in conjunction with the accompanying drawings.

### BRIEF DESCRIPTION OF THE DRAWINGS

FIG. 1 is a block view showing a network construction of a system as an application object of an encryption communication module having a communication method according to the invention in a first embodiment;

FIG. 2 is a block view showing an internal processing architecture of a user terminal or a service providing server in which the encryption communication module having the communication method of the invention operates in the first embodiment;

FIG. 3 is a block view showing a software construction of a user terminal or a service providing server inclusive of the encryption communication module having the communication method of the invention in the first embodiment;

FIG. 4 is a table showing location information in the first embodiment;

FIG. 5 is a table showing a policy list in the first embodiment;

FIG. 6 is a table showing an SP table in the first embodiment;

FIG. 7 is a table showing a reception SA table in the first embodiment;

FIG. 8 is a table showing a transmission SA table in the first embodiment;

FIG. 9 is a table showing a location database in the first embodiment;

FIG. 10 is a table showing an NAPT translation table in the first embodiment;

FIG. 11 is a sending/receiving sequence diagram when an encryption communication line is established between UAC and UAS with data packet transmission from a UAC side application as a start and encryption communication is started in the first embodiment;

FIG. 12 is a sending/receiving sequence diagram when an encryption communication line is established between UAC and UAS with a communication start request from a UAC side application to an encryption communication module as a start and encryption communication is started in the first embodiment;

FIG. 13 is a sending/receiving sequence diagram when an encryption communication line is established between UAC and UAS, and then a data packet is sent by using the encryption communication line from a UAC side application to a UAS side application in the first embodiment;

FIG. 14 is a sending/receiving sequence diagram when an encryption communication line is established between UAC and UAS, and then a data packet is sent by using the encryption communication line from a UAS side application to a UAC side application in the first embodiment;

FIG. 15 is an explanatory view showing a data structure of a location registration request message in the first embodiment;

FIG. 16 is an explanatory view showing a data structure of a location registration response message in the first embodiment;

FIG. 17 is an explanatory view showing a data structure of a URI acquisition request message in the first embodiment;

FIG. 18 is an explanatory view showing a data structure of a URI acquisition response message in the first embodiment;

FIG. 19 is an explanatory view showing a data structure of a communication start request message in the first embodiment;

FIG. 20 is an explanatory view showing a data structure of a communication start response message in the first embodiment;

FIG. 21 is an explanatory view showing a data structure of an IP packet not encrypted in the first embodiment;

FIG. 22 is an explanatory view showing a data structure of an IPsec tunnel mode form packet having an UDP header in the first embodiment;

FIG. 23 is a flowchart showing a flow for deciding to apply capsulation processing to be executed when an encryption communication module having communication method of the invention receives a receipt (RX) packet from a network interface driver in the first embodiment;

FIG. 24 is a flowchart showing a flow for deciding to apply a capsulation processing to be executed when the encryption communication module with communication method of the invention receives a transmission (TX) packet from an IP processing of an OS in the first embodiment;

FIG. 25 is a flowchart showing a flow for deciding to apply a decapsulation processing to be executed when the encryption communication module with communication method of the invention receives a receipt packet from a UDP processing of the OS in the first embodiment;

FIG. 26 is a flowchart showing a flow of an encapsulation processing of the transmission packet called from the decision to apply the capsulation processing of the encryption communication module with communication method of the invention in the first embodiment;

FIG. 27 is a block diagram showing a network construction of a system as an application object of an encryption communication module having a communication method of the invention in a second embodiment;

FIG. 28 is a block diagram showing an internal processing architecture of an NAPT router with encryption communication function on which the encryption communication module having the communication method of the invention operates in the second embodiment;

FIG. 29 is a block diagram showing a software construction of the NAPT router with encryption communication function and inclusive of an encryption communication module of the communication method of the invention in the second embodiment;

FIG. 30 is a flowchart showing a flow for deciding to apply a capsulation processing to be executed when the encryption communication module having the communication method of the invention receives a forwarding packet from an IP termination/address translation/forwarding process of OS in the second embodiment;

FIG. 31 is a flowchart showing a flow for deciding to apply a capsulation processing to be executed when the encryption communication module having the communication method of the invention receives a forwarding packet from a network interface driver (LAN side) in the second embodiment;

FIG. 32 is a flowchart showing a flow of a decapsulation processing of a forwarding packet called from a decision to apply a capsulation processing of the encryption communication module having the communication method of the invention in the second embodiment;

FIG. 33 is a flowchart showing a flow of a capsulation processing of a forwarding packet called from a decision to apply a capsulation processing of the encryption communication module having the communication method of the invention in the second embodiment;

FIG. 34 is a block diagram showing a network construction of a system as an application object of an encryption communication module having a communication method of the invention in a third embodiment;

FIG. 35 is a sending/receiving sequence diagram when a data packet is sent from a UAC side application to a UAS side application by using an encryption communication line after the encryption communication line is established between UAC and UAS in the third embodiment;

FIG. 36 is a sending/receiving sequence diagram when a data packet is sent from a UAS side application to a UAC side application by using an encryption communication line after the encryption communication line is established between UAC and UAS in the third embodiment 3; and

FIG. 37 is a block diagram showing a network construction of a system as an application object of an encryption communication module having a communication method of the invention in a fourth embodiment.

### DESCRIPTION OF THE EMBODIMENTS

The invention will be hereinafter explained in further detail with reference to the accompanying drawings.

### First Embodiment

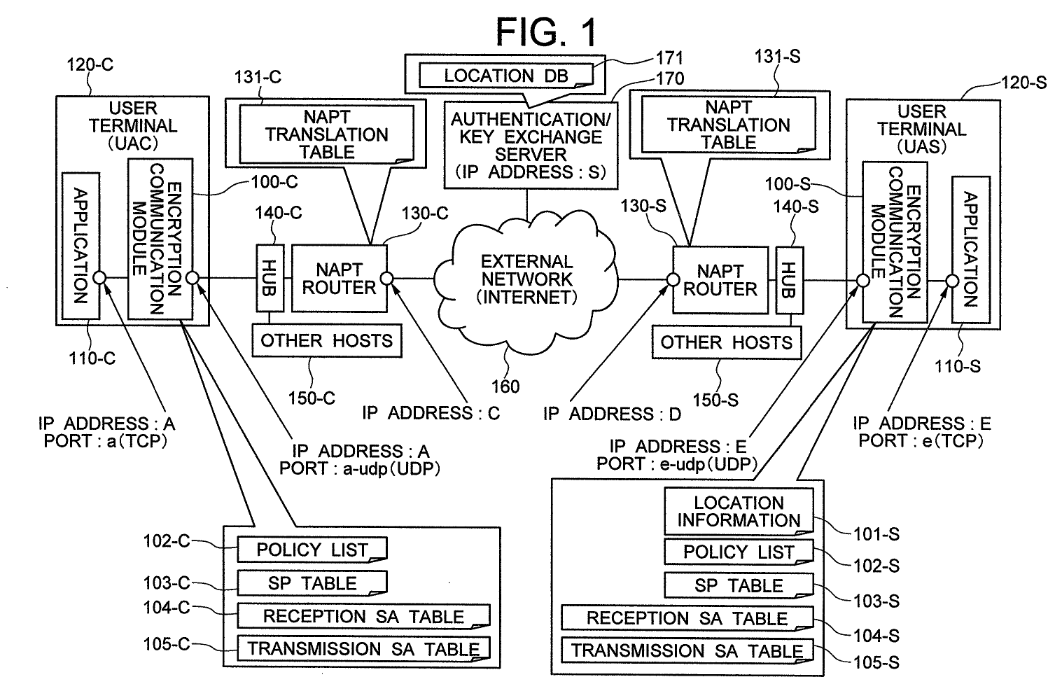

FIG. 1 shows a network construction of a system as an application object of an encryption communication module having a communication method of the invention in the first embodiment.

A user terminal 120-C and a service providing server 120-S are connected to an external network 160 such as the Internet through NAPT routers 130-C and 130-S, respectively. The network between the user terminal 120-C and the NAPT router 130-C is a user terminal side LAN and the network between the NAPT router 130-C and the NAPT router 130-S is WAN. The network between the NAPT router 130-S and the service providing server 120-S is a service providing server side LAN.

Generally, private IP addresses are used for the user terminal side LAN and the service providing server side LAN and a global IP address is used for WAN. It will be assumed that this arrangement is employed in this embodiment, too, but such an address allocation is not always essential. It will be assumed that a private IP address A is allocated to the user terminal 120-C, a global IP address C is allocated to a WAN side interface of the NAPT router 130 on the user terminal side, a global IP address D is allocated to a WAN side interface of the NAPT router 130 on the service providing server side and a private IP address E is allocated to the service providing server 120-S.

One or more hosts 150-C other than the user terminal 120-C may exist inside the user terminal side LAN as shown in the drawing. A HUB 140-C for connecting these hosts to the LAN and similar communication devices (switches, routers, etc) may be installed. To execute the embodiment of the invention, it is essentially necessary that the user terminal 120-C installed inside the LAN is able to communicate with an authentication/key exchange server 170 and with the service providing server 120-S by using the IP address allocated to the user terminal 120-C itself. When this condition is satisfied, the number of hosts inside the LAN and the network construction are not limited. This also holds true of the service providing server side LAN.

Each of the NAPT routers 130-C and 130-S has an NAPT translation table 131-C and 131-S and translates the IP address and the TCP•UDP port number contained in the IP packet forwarded between the LAN side and the WAN side by using the translation table.

The authentication/key exchange server 170 is arranged in the external network 160. It will be assumed that the authentication/key exchange server 170 is realized as an SIP server. The authentication/key exchange server 170 stores therein a URI associated with the service of the service providing server and a location database 171 representing association of the IP address and the port number.

The application server 110-S and the encryption communication module 100-S operates inside the service providing server 120-S. Similarly, the application client 110-C and the encryption communication module 110-C operate inside the user terminal 120-C. The application server 110-S and the application client 110-C will be hereinafter called together “applications”.

The applications 110-C and 110-S are software for accomplishing the original object in that the user terminal 120-C communicates with the service providing server 120-S and realizes the service. A communication packet to be exchanged to and from the host of the other side of communication (user terminal 120-C for service providing server 120-S and service providing server 120-S for user terminal 120-C) is sent and received with the encryption communication nodule 100-C or 100-S in the form of the IP packet of a plain text.

The encryption communication modules 100-C and 100-S authenticate the host of the other side of communication by using the authentication/key exchange server 170, exchange the communication starting request and its response with the host of the other side of communication through the authentication/key exchange server 170 and share the key information with the host of the other side. In this embodiment, the encryption communication module 100-S operates as an SIPS client and executes these processing by using an SIP protocol encrypted by TLS. In this embodiment, the communication start request takes the form of an SIP message and is sent from the encryption communication module 100-C of the user terminal 120-C as the source to the encryption communication module 100-S of the service providing server 120-S through the authentication/key exchange server 170. Therefore, it is possible to regard the user terminal 120-C as a UAC (User Agent Client) of SIP and the service providing server 120-S as UAS (User Agent Server) of SIP.

The encryption communication modules 100-C and 100-S decode the encryption communication packet of the IPsec tunnel mode form received from the other side of communication by using the key information obtained by the processing described above and forward the packet as an IP packet of the plain text to the application 110-C or 110-S. The encryption communication modules 100-C and 100-S encrypt the IP packet of the plain text received from the application server 110-C or 110-S and send the packet as the encryption communication packet of the IPsec tunnel mode form to the other side. Incidentally, to execute encryption communication with the user terminal 120-C through the NAPT routers 130-C and 130-S, the encryption communication module 100-S on the service providing server side must be equipped with the communication method according to the invention. On the other hand, the encryption communication module 100-C on the user terminal side need not always be equipped with the communication method of the invention.

The encryption communication module 100-S on the side of the service providing server 120-S stores therein location information 101-S, a policy list 102-S, an SP(Security Policy) table 103-S, a for-receiving SA(Security Association) table 104-S and a transmission SA table 105-S. Similarly, the encryption communication module 100-C on the side of the user terminal stores therein a policy list 102-C, an SP table 103-C, a reception SA table 104-C and a transmission SA table 105-C.

The location information is the information registered by the service providing server 120-S holding this information to a location database 171 of an authentication/key exchange server 170.

The policy lists 102-S and 102-C are the tables that are used to judge whether a capsulation processing or a decapsulation processing is to be made for an IP packet or is to be discarded without any processing when the encryption communication module 100-S or 100-C receives the IP packet from the network interface and the application.

The SP tables 103-S and 103-C are tables representing the association of information about the SPI values contained in the IPsec tunnel mold form packet, an outside IP header of the corresponding IPsec tunnel mode form packet, an outside UDP header, an inside IP header, an inside TCP•UDP header, an IP header of an IP packet of the plain text and a TCP•UDP header. Reception SA tables 104-S and 104-C are tables for storing the SPI value contained in the IPsec tunnel mode form packet and key information corresponding to the former.

A transmission SA tables 105-S and 105-C are tables for storing the SPI value contained in the IPsec tunnel mode form packet and key information corresponding to the former.

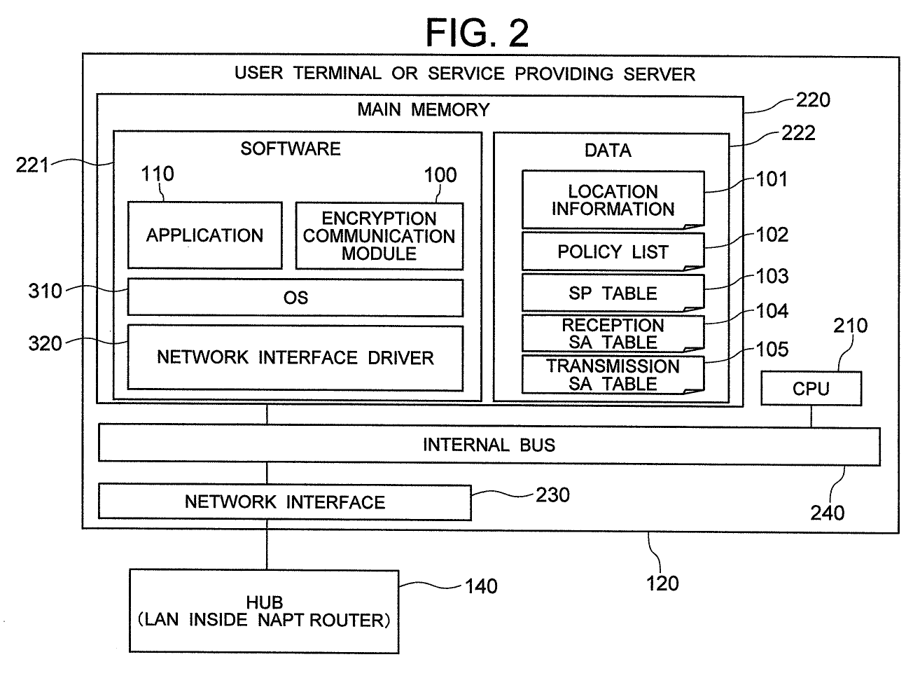

FIG. 2 shows an internal processing architecture of the user terminal or the service providing server on which the encryption communication module having the communication method of the invention operates in the first embodiment.

Internal hardware of the user terminal or service providing server 120 includes a CPU 210, a main memory 220, a network interface 230 and an internal bus 240 connecting these members. Needless to say, the internal hardware may contain other hardware.

The main memory 220 stores software 221 and data 222 to which access is made from the software. The CPU 210 reads and executes the software 221. The network interface 230 is connected to the network (LAN on the user terminal side or the service providing server side) in which the user terminal or the service providing server 210 is installed.

The software 221 includes the application 110, the encryption communication module 100, the OS 310 and a network interface driver 320. Needless to say, the software may include other kinds of software. The OS 310 contains a sending/receiving processing of IP•TCP•UDP. Besides them, the OS 310 may contain ordinarily other processing such as process management, memory management, input/output driver management, and so forth. The network interface driver 320 is a kind of the input/output driver that controls the network interface 230 and executes input/output of the communication packets and layer-2 processing of the communication packets. Incidentally, the network interface driver 320 and the OS 310 are separate software in this embodiment but a part or the whole of the functions of the network interface driver 320 may be contained in the OS 310.

Data 222 contains location information 101, the policy list 102, the SP table 103, the reception SA table 104 and the transmission SA table 105 as the data that is used by the encryption communication module 100. However, the location information 101 need not be contained in the user terminal. Other data may be of course contained, too.

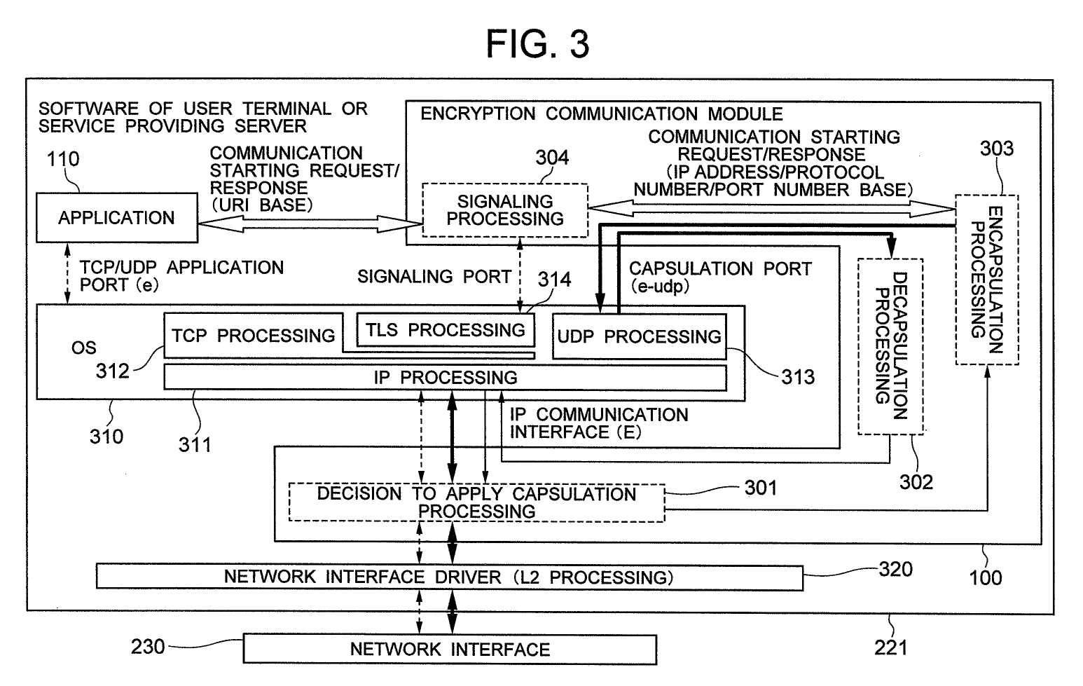

FIG. 3 is a block diagram showing a software construction of the user terminal or service providing server containing the encryption communication module having the communication method of the invention.

The OS 310 contains an IP processing 311, a TCP processing 312, a UDP processing 313 and a TLS processing 314. Though these kinds of processing are contained in the OS 310 in this embodiment, they may be placed outside (library, for example) the OS 310 as long as similar functions can be accomplished and the embodiment can be likewise executed.

The IP processing 311 executes a sending processing of the IP packet with this side as a source and a receiving processing of the IP packet with this side as the destination. The IP packet sending processing adds a suitable IP header to the IP payload received from a high order processing (TCP processing, UDP processing or application directly using IP) and sends the IP packet to the network interface driver of a suitable IP communication interface (network interface to which the IP address is allocated) corresponding to the destination IP address. The IP packet receiving processing judges whether or not the IP packet received from the network interface driver of the IP communication interface is the IP packet addressed to the host of this side and delivers the IP payload of that packet to processing of the high order corresponding to the protocol number contained in the IP header of the packet when the IP packet is address to the host of this side.

Incidentally, whether or not an IP header checksum contained in the IP header of the IP packet received is correct is judged, too, in the receiving processing of the IP packet in the IP processing 311. (The IP packet is discarded when this value is not correct.) In the IP packet sending processing, the correct value of the IP header checksum is calculated and is set to the IP header of the sending IP packet.

The TCP processing 312 executes the sending/receiving termination processing of the TCP protocol. In other words, the TCP processing 312 executes a processing for establishing and cutting off the TCP connecting with and from the other side of communication designated by the high order processing (application using TCP), a processing for dividing the sending data stream given from the high order processing into segments, constituting the TCP data packet and sending the packet through the IP processing 311, a processing for rearranging the TCP data packets received through the IP processing 311 in accordance with the sequence number, constituting the receiving data stream and delivering the data stream to the processing of the high order corresponding to the destination port number contained in the TCP header and a processing for sending again the TCP data packet for which a reception confirmation packet is not arrived from the other side of communication.

Incidentally, whether or not a TCP packet checksum contained in the TCP header of the TCP packet received is correct is judged, too, in the TCP packet receiving processing in the TCP processing 312. (The TCP packet is discarded when this value is not correct.) In the TCP packet sending processing, the correct value of the TCP header checksum is calculated and is set to the TCP header of the sending TCP packet.

The UDP processing 313 executes the sending/receiving processing of the UDP protocol. In other words, the UDP processing 313 executes processing for adding a suitable UDP header to a sending UDP payload given from a processing of a high order (application using UDP) and delivering it through the IP processing and processing for delivering the UDP packet received through the IP processing 311 to high order processing corresponding to the destination port number contained in the UDP header.

Incidentally, whether or not a UDP packet checksum contained in the UDP header of the UDP packet received is correct is judged, too, when the value of the UDP packet checksum is not 0 in the UDP packet receiving processing in the UDP processing 313. (The UDP packet is discarded when this value is not correct.) In the UDP packet sending processing, 0 or the correct value of the UDP packet checksum is set to the UDP header of the sending UDP packet.

The TLS processing 314 executes the processing relating to encryption communication. In other words, the TLS processing 314 executes processing for establishing and cutting off a TLS encryption communication route with the other side of communication designated by high order processing (application using TLS), processing for encrypting a sending plain text data stream given by high order processing and sending it through the TCP processing 312, decrypting the encrypted data stream received through the TCP processing to constitute a receiving plain text data stream and delivering it to a suitable high order processing.

The encryption communication module 100 contains a decision to apply a capsulation processing 301, a decapsulation processing, an encapsulation processing 303 and a signaling processing 304. The decision to apply a capsulation processing 301 is interposed between an IP communication interface corresponding to a network interface 230 of the IP processing 311 and a network interface driver 320 corresponding to the network interface 230 and judges for the IP packet to be sent and received as to whether the decapsulation processing 302 or the encapsulation processing should be made, whether or not the IP packet should be handed over as such to the IP processing 311 and the network interface driver 320 without executing any processing and whether or not the IP packet should be discarded without any processing. The processing is executed in accordance with the result of the decision.

The decapsulation processing 302 waits by using the UDP processing 313 for the reception of the UDP packet having the LAN side value of the port number of the own host side used for the external UDP header of the IPsec tunnel mode form (port number e-udp in the service providing server in the case of FIG. 1 and the port number a-udp in the user terminal). After receiving the corresponding UDP packet, the decapsulation processing 302 receives the UDP payload from the UDP processing 313, executes confirmation of the authentication value of the packet and decoding and hands over the plain text IP packet to the IP processing 311.

The capsulation processing 303 receives the plain text IP packet the encryption of which is judged as being to be made by the decision to apply capsulation processing 301, encrypts the packet, adds a suitable header, etc and sends the packet as the UDP packet having the LAN side value of the port number on the own host side used for the UDP header of the IPsec tunnel model form (port number e-udp in the service providing server in the case of FIG. 1 and the port number a-udp in the user terminal) as source port number. Incidentally, when the encryption communication route necessary for this encryption processing has not yet been established, the communication starting request is made to the signaling processing 304. As a result, when the encryption communication route is established, the capsulation processing encrypts and sends the packet.

The signaling processing executes 304 communication for establishing and releasing the IPsec encryption communication line with the host of the other side of communication (which communication will be hereinafter called “signaling”). In other words, the signaling processing executes the communication for establishing the encryption communication line and its pre-processing such as the registration of location information to the authentication/key exchange server 170, inquiry of URI representing the other side of communication and the communication starting request/response to the host of the other side through the authentication/key exchange server 170. In this embodiment, these kinds of communications are carried out by using the SIP message encrypted by the TLS processing 314.

The application 110 executes communication of TCP and UDP with the host of the other side of communication by the standard method prepared by the OS 310 through the IP processing 311, the TCP processing 312 and the UDP processing 313. (In the case of FIG. 1, the port number of the host of this side of communication is e for the service providing server and a for the user terminal.) When the application 110 knows in advance the URI of the other side of communication, the start of encryption communication may be requested to the signaling processing 304 inside the encryption communication module by using this URI.

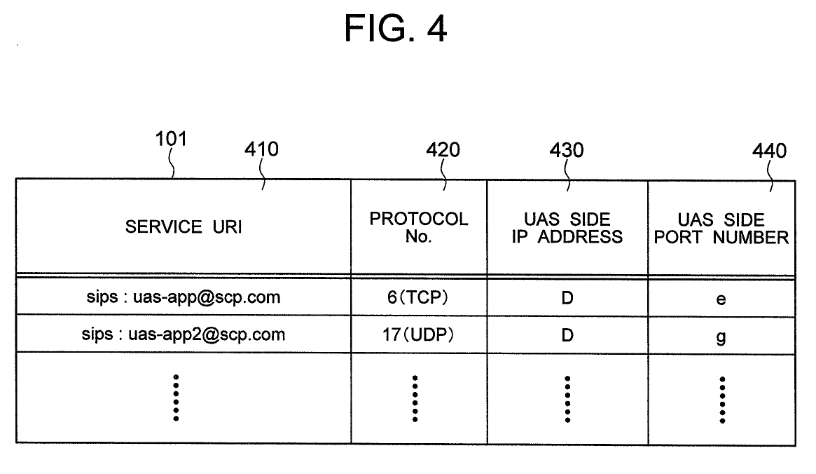

FIG. 4 shows the location information in the first embodiment.

The location information 101 contains the items of a service URI 410, a protocol number 420, an IP address 430 on the UAS side and a port number 440 on the UAS side.

It will be assumed that a manager of the service providing server manually sets these items in this embodiment. As for the IP address 430 on the UAS side, however, it may be automatically acquired by using a method such as UPnP (Universal Plug and Play) from the NAPT router 130-S on the service providing server side. An application server operating on the service providing server may automatically set the items of the service URI 410, the protocol number 420 and the port number 440 on the UAS side.

The service URI 410 is an SIPS URI associated with the application service provided by the service providing server.

The protocol number 420 stores the protocol number used for the communication with the application provided by the service providing server. Incidentally, the term “protocol” used hereby means the protocol that is used in the high order layer immediately above the IP layer. The protocol number is the number allocated by an organization such as IANA (Internet Assigned Number Authority) in such a fashion as to correspond to each protocol and is stored in the protocol number field of the IP header. TCP or UDP is used as the protocol in ordinary applications.

The IP address 430 on the UAS side stores the IP address of the service providing server. In this embodiment, the service providing server 120-S and the user terminal 120-C exist inside the LAN to which private IP addresses under different managements are allocated, respectively, while sandwiching the external network 160 and cannot communicate with each other by using the private IP address. Therefore, the global IP address of the NAPT router 130-S on the service providing server side (IP address D in FIG. 1) must be registered to the IP address on the UAS side.

The port number 440 on the UAS side stores the port number of TCP or UDP by which the application service provided by the service providing server waits for the communication from the user terminal.

Incidentally, when the URI is uniquely determined for the IP address on the service providing server side irrespective of the protocol number and the application port number on the service providing server side, the items of the protocol number 420 and the port number 440 on the UAS side may be omitted.

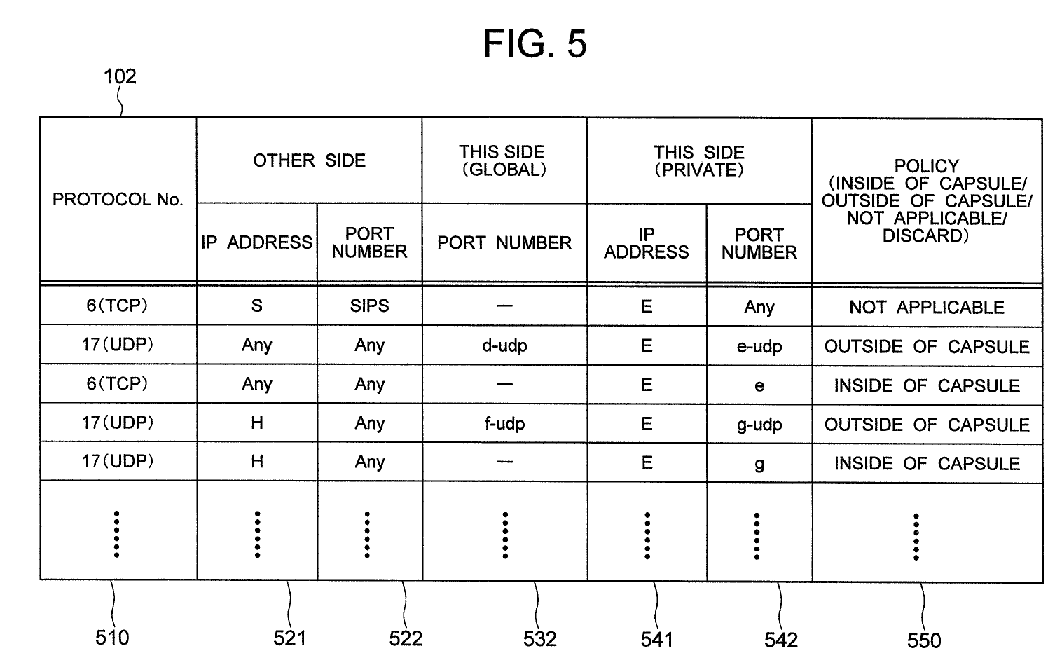

FIG. 5 shows a policy list in the first embodiment.

The policy list 102 contains a protocol number 510, an IP address 521 of the other side of communication, a port number 522 of the other side, this side (global) port number 532, this side (private) IP address 541, this side (private) port number 542 and a policy 550.

It will be assumed hereby that a manager of the corresponding host (user terminal or service providing server) manually set these items in this embodiment. As for a part of the protocol number 510, this side (global) port number 532, this side (private) IP address 541 and this side (private) port number 542, however, setting with the NAPT router may be synchronized as will be described later.

The protocol number 510 stores the protocol number of the IP packet as the application object of the policy of the corresponding entry.

The IP address 521 on the other side stores the other side IP address (destination IP address for the sending IP packet and source IP address for the receiving IP packet) as the application object of the policy of the corresponding entry.

The other side port number 522 stores the other side TCP•UDP port number of the IP packet (destination port number for the sending IP packet and source port number for the receiving IP packet) as the application object of the policy of the corresponding entry.

This side (global) port number 532 stores this side TCP•UDP port number (source port number for the sending IP packet and destination port number for the receiving IP packet) that is used when the IP packet as the application object of the policy of the corresponding entry flows outside the LAN of this side.

This side (private) IP address 541 stores this side IP address (source IP address for the sending IP packet and destination IP address for the receiving IP packet) used when the IP packet as the application object of the policy of the corresponding entry flows inside the LAN of this side (inclusive of the inside of the host of this side host).

This side (private) port number 542 stores this side TCP•UDP port number (source port number for the sending IP packet and destination port number for the receiving IP packet) used when the IP packet as the application object of the policy of the corresponding entry flows inside the LAN of this side (inclusive of the host of this side).

The policy 550 stores the policy applied by the corresponding entry. The kind of the policy in this embodiment is four kinds, i.e. “inside of capsule”, “outside of capsule”, “not applicable” and “discard”.

In order for the invention to operate in this embodiment, it is necessary that a policy in the policy list 102 must operate as the service providing server and a suitable port number must be registered to this-side (global) port number 532 for the entry in which the policy is “outside of policy”. Generally, the protocol number 510 of the corresponding entry, this-side (global) port number 532, this-side (private) IP address 541 and this-side (private) port number 542 must be registered as a static NAPT entry to the NAPT translation table 131-S of the NAPT router on the service providing server side. (Otherwise, the service providing server cannot receive the packet sent from the user terminal to the service providing server.)

In this way, setting of the partial entry of the policy list 102-S of the service providing server and setting of the static NAPT entry of the NAPT translation table 131-S on the service providing server side must be synchronized with each other. This synchronization may be established either manually by the manager or by using means such as the UPnP so that the encryption communication module 100-S of the service providing server acquires the static NAPT entry from the NAPT router 130 on the side of the service providing server. Alternatively, the encryption communication module 100-S of the service providing server 100-S adds a suitable static NAPT entry to the NAPT router 130-S on the service providing server side to establish synchronization.

This-side (global) port number 532 may remain blank for those entries which do not operate as the service providing server and those in which the policy is “inside of capsule”). In the policy list 102-C of the user terminal, this-side (global) port numbers 532 may all remain blank.

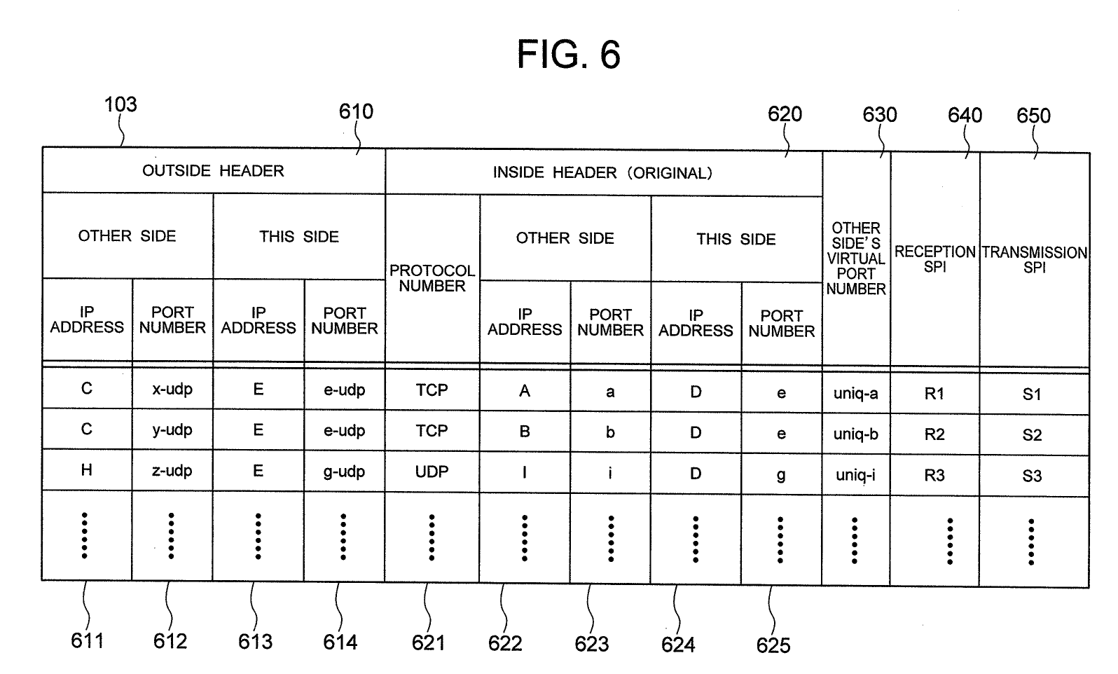

FIG. 6 shows an SP table in the first embodiment.

The SP table 103 contains items of a parameter 610 of an outside header, a parameter 620 of an inside header, an other-side virtual port number 630, reception SPI 640 and transmission SPI 650. The parameter 610 of the outside header contains items of other-side IP address 611, other-side port number 612, this-side IP address 613 and this-side port number 614. The parameter 620 of the inside header contains items of a protocol number 621, other-side IP address 622, other-side port number 623, this-side IP address 624 and this-side port number 625.

The entry of the SP table 103 is automatically generated on the basis of the location information 101, the content of the policy list 102, the information acquired through the authentication/key exchange server 170 and the information contained in the headers of the data packet to be sent and received. Each entry of the SP table 103 corresponds to each bidirectional encryption communication line interposed between the user terminal 120-C and the service providing server 120-S.

Other side's and this side's IP addresses and port numbers that are used for the outside IP header of the IPsec tunnel mode form and the outside UDP header are stored in each item of the parameter 610 of the outside header. These IP addresses and port number are used when the IPsec mode tunnel mode form packets are handled inside this-side host. In other words, this-side IP address and port number are private IP address and port number used inside this-side LAN and other-side IP address and port number are global IP address and port number used outside other-side LAN.

Other side's and this side's IP addresses and port numbers that are used for the inside IP header of the IPsec tunnel mode form and the inside TCP•UDP header are stored in each item of the parameter 620 of the inside header. These IP addresses and port numbers are used in the inside header of the encrypted IP sec tunnel mode form. In other words, this-side IP address and port number are private IP address and port number used inside this-side LAN and the protocol number and other-side IP address and port number are the IP address and the port number of the application 110-S on the service providing server side that are recognized by the application 110-C on the user terminal side. In the service providing server 120-C, the values of the IP address and port number in the user terminal 120-C are counterchanged between this side and other side.

Other-side virtual port number 630 is a virtual other-side port number so allocated as to take a unique value in all the entries in which the value of the item of other-side IP address 611 of the outside header is the same.

Reception SPI 640 represents a value of SPI used in the receipt packet. When receiving the IPsec tunnel mode form packet, reception SPI in the packet rewrites the IP address and the port number of the packet header by using the entry which is coincident with the value of the item of this reception SPI 640.

Transmission SPI 650 is a value of the SPI used for the transmission packet. A value that is different from or the same as the value of the reception SPI 640 may be used for this value. When the IPsec tunnel mode form packet is sent, the value of the item of this transmission SPI 650 is set to the SPI field of the packet.

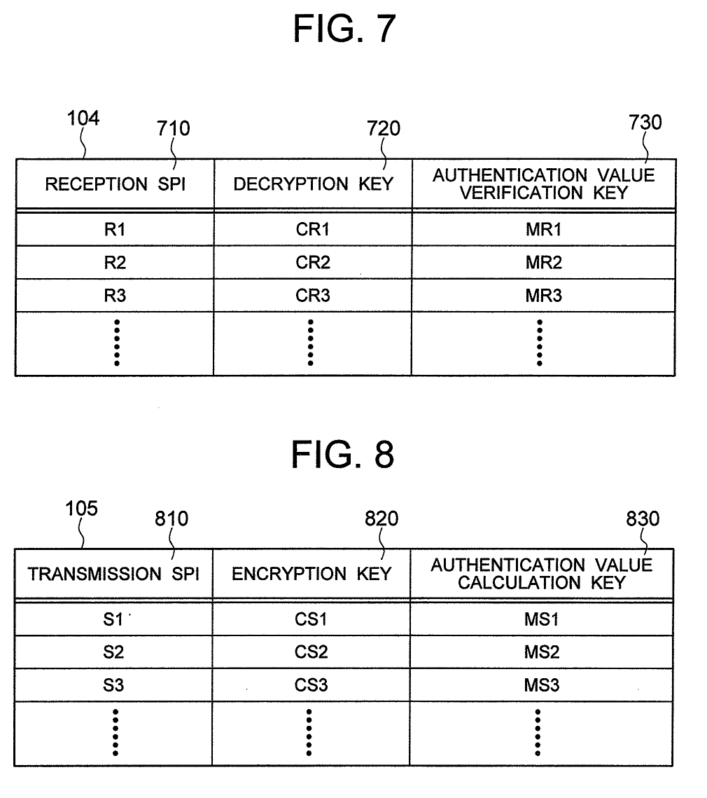

FIG. 7 shows a reception SA table in the first embodiment.

The reception SA table 104 contains items of reception SPI 710, a decryption key 720 and a authentication value verification key 730.

Entry of the reception SA table 104 is automatically generated for each reception SPI value used in the SP Table.

Reception SPI 710 is a value of the SPI used for the receipt (RX) packet. When the IPsec tunnel mode form packet is received, decryption of the packet and confirmation of the authentication value are executed by using the entry in which the SPI contained in that packet is coincident with the value of the item of this reception SPI 710.

The decryption key 720 is the one that corresponds to the reception SPI.

The authentication value verification key 730 is the one that corresponds to the reception SPI.

FIG. 8 shows a transmission SA table in the first embodiment.

The transmission SA table 105 contains items of transmission SPI 810, an encryption key 820 and a authentication value calculation key 830.

Entry of the transmission SA table 105 is automatically generated for each value of transmission SPI used in the SP Table.

Transmission SPI 810 is a value of the SPI used for the transmission (TX) packet. When the IPsec tunnel mode form packet is transmitted, encryption of the packet and calculation of the authentication value are executed by using the entry in which the SPI set to the SPI field of the packet is coincident with the value of the item of this transmission SPI 810.

The encryption key 820 is the one that corresponds to the transmission SPI.

The authentication value calculation key 830 is the one that corresponds to the transmission SPI.

In this embodiment, the reception SA table 104 and the transmission SA table 105 are prepared separately to make it possible to use separate values for the reception SPI and the transmission SPI in this embodiment but they can be gathered into one SA table when the same value is used for the reception SPI and the transmission SPI.

In this embodiment, the decryption key and the authentication value verification key used at the time of reception of the packet, and the encryption key and the authentication value calculation key used at the time of sending, are prepared as separate items. However, when the same value is used for the reception SPI and the transmission SPI, a common encryption key is used for encryption and moreover the same key is used for receiving and sending the packet, the decryption key and the encryption key of the same SPI take the same value. Similarly, when the same value is used for the reception SPI and the transmission SPI, a verification algorithm using a common key such as HMAC for calculation and confirmation of the authentication value and the same key is used at the time of sending and reception of the packet, the authentication value verification key and the authentication value calculation key of the same SPI take the same value. Furthermore, when an algorithm using a common key for both encryption and authentication is used, the keys for both of them may be the same.

In this way, diversified allocation methods may be possible for allocating SPI and the keys for encryption and authentication depending on the encryption/authentication algorithm and on the modes of usage of the SPI and the keys for sending and receiving. The invention is applicable irrespective of the allocation method of the SPI and the key and of the selection of the encryption/authentication algorithm used.

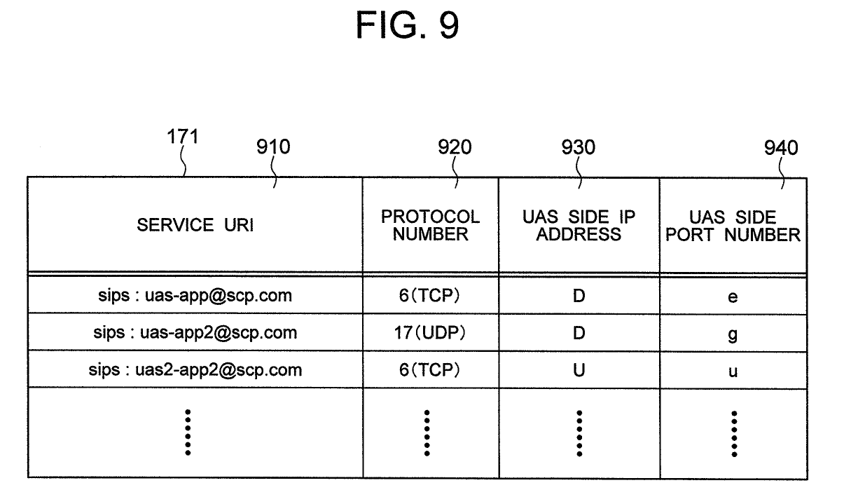

FIG. 9 shows a location database in the first embodiment.

The location database 171 contains items of a service URI 910, a protocol number 920, a UAS side IP address 930 and a UAS side port number 940 in the same way as the location information 101. These items are reported from the service providing server 120-S to the authentication/key exchange server 170 on the basis of the location information 101 and each entry is set on the basis of this report.

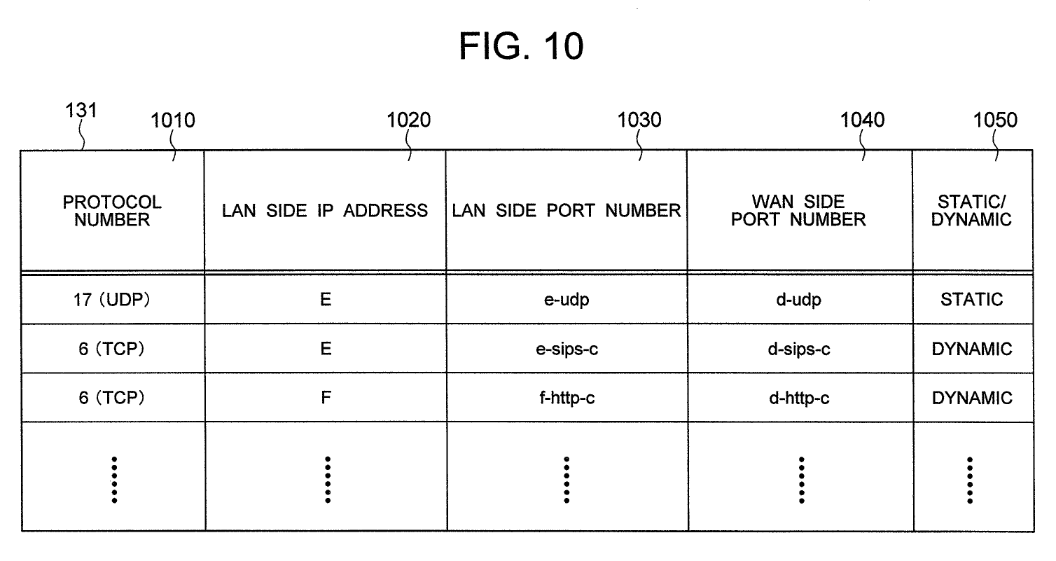

FIG. 10 shows an NAPT translation table in the first embodiment.

The NAPT translation table 131 contains items of a protocol number 1010, a LAN side IP address 1020, a LAN side port number 1030, a WAN side port number 1040 and a static/dynamic 1050.

The NAPT translation table 131 represents a translation rule of the IP address and the port number at the time of forwarding of the packet in the NPT router. In other words, when the NAPT router receives the IP address allocated from the WAN side network to the WAN side network interface as its destination, the entry having the protocol number contained in the IP header of that packet and the destination port number contained in the TCP•UDP header that are coincident with the protocol number 1010 and the WAN side port number 1040 is searched from the NAPT translation table 131. When the coincident entry is found out, the values of the destination IP address of the IP header of that packet and the destination port number of the TCP•UDP header are rewritten by the LAN side IP address 1020 and the LAN side port number 1030 of the entry and the packet is then forwarded to the LAN side network interface. When the coincident entry is not found out, that packet is discarded.

On the contrary, when the NAPT router receives the IP packet having its destination at the IP address existing on the WAN side from the WLAN side network, the entry having the protocol number contained in the IP header of that packet, the source IP address and the source port number contained in the TCP•UDP header that are coincident with the values of the protocol number 1010, the LAN side IP address 1020 and the LAN side port number 1030 is searched from the NAPT translation table 131. When the coincident entry is found out, the value of the source port number of the TCP•UDP header is rewritten by the WAN side port number 1040 and the value of the source IP address of the packet is rewritten by the IP address allocated to the WAN side network interface and the packet is forwarded to the WAN side network interface. When the coincident entry is not found out, a suitable WAN side port number not used by other entries is allocated afresh and a dynamic entry is generated in the NAPT translation table 131 by using the new WAN side port number. A similar packet is forwarded on the basis of this dynamic entry.

The entries of the NAPT translation table 131 include dynamic entries and static entries. When the corresponding entry is not found out in the NAPT translation table 131 at the time of forwarding of the packet from the LAN side to the WAN side, the dynamic entry is generated afresh as described previously. When the communication is judged as being finished (judgment by detection of end sequence of TCP connection and non-passage of the packet for predetermined time), the entry is deleted from the NAPT translation table 131. On the other hand, the static entries are those which are registered by manual setting by the manager of the NAPT router and automatic setting from outside using UPnP. Generally, the static entry is not deleted from the NAPT translation table 131 unless deletion setting of the entries is made. In the NAPT router 130 of this embodiment, each entry distinguishes the dynamic and static entries by using the items of the static/dynamic 1050 contained in the NAPT translation table 131 but the invention can be worked without being limited to this method.

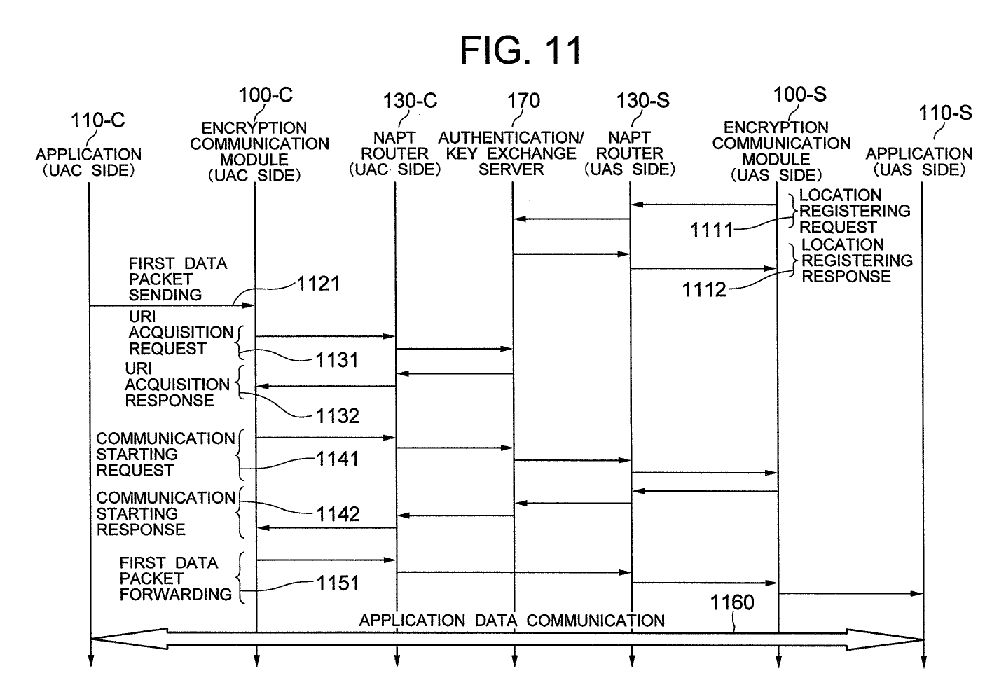

FIG. 11 is a sending/receiving sequence diagram when the encryption communication line is established between UAC and UAS with sending of the data packet from the UAC side application as a start and the encryption communication is started in the first embodiment.

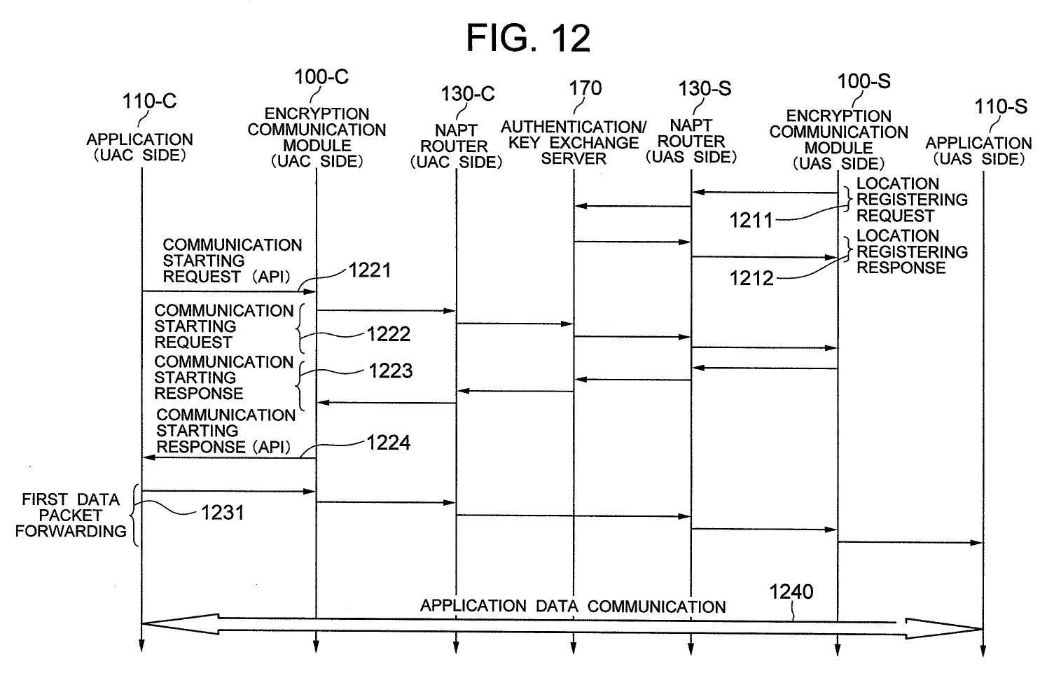

When SIP is used for the communication message between the encryption communication module 100 and the authentication/key exchange server 170, a message for reporting “under processing” and a message for confirming the reception of response are also sent and received besides the messages shown in the sequence diagrams in FIGS. 11 and 12. Since these messages do not essentially affect the embodiment of the invention, they are omitted from the sequence diagrams in FIGS. 11 and 12.

First, the encryption communication module 100-S on the side of the service providing server (UAS) sends a location registration request message to the authentication/key exchange server 170 on the basis of the location information 101 it has by itself (step 1111). This message reaches the authentication/key exchange server 170 through the NAPT router 130-S on the service providing server side. The authentication/key exchange server 170 registers the location information contained in the message to its own location database 171. This server 170 returns the location registration response message representing completion of the registration to the encryption communication module on the service providing server side through the NAPT router 130-S on the service providing server side (step 1112).

Next, the application 110-C on the user terminal (UAC) side sends the first data packet to the application 110-S on the service providing server side (step 1121). It will be assumed that the application 110-C on the user terminal side knows in advance either the IP address of the service providing server as the destination of the packet at this time or FQDN (Full Qualified Domain Name) and acquires the IP address of the service providing server by using DNS (Domain Name System) on the basis of such an IP address or FQDN. It will be assumed further that the application 110-C on the user terminal side knows in advance the protocol number of the packet and the destination port number.

Incidentally, the term “data packet” used hereby means all the packets involved in the communication between the application 110-C on the user side and the application 110-S on the service providing server side and is irrelevant as to whether or not the data directly used by the application is contained in the packet. When TCP is used for the communication between the application 110-C on the user terminal side and the application 110-S on the service providing server side, for example, sending of the TCP SYN packet executed in the initial stage of the establishment of the TCP connection is sending of the first data packet.

Detecting that sending of the first data packet is made from the application, the encryption communication module 100-C on the user terminal side sends a URI acquisition request message to the encryption/key exchange server 170 on the basis of the destination IP address, the protocol number and the destination port number of the data packet, (step 1131). This message arrives at the authentication/key exchange server 170 through the user side NAPT router 130-C. The authentication/key exchange server 170 examines the corresponding URI by retrieving the location database 171 of its own and returns the URI acquisition response message containing the URI to the encryption communication module 100-C on the side of the user terminal through the user terminal side NAPT router 130-C (step 1132).

Subsequently, the encryption communication module 100-C on the user side sends the communication start request message containing the URI and the key information acquired to the authentication/key exchange server 170 (step 1141). This message arrives at the authentication/key exchange server 170 through the user terminal side NAPT router 130-C. The authentication/key exchange server 170 decides the forwarding destination of the message on the basis of the URI contained in this message and forwards the message to the encryption communication module 100-S on the service providing server side through the NAPT router 130-S on the service providing server side. Receiving this message, the encryption communication module 100-S on the service providing server side returns the communication start response message containing the corresponding key information to the authentication/key exchange server 170 through the NAPT router 130-S on the service providing server side. Receiving this message, the authentication/key exchange server 170 returns the message to the encryption communication module 100-C through the NAPT router 130-C on the user terminal side (step 1142).

As a result of the processing described above, the parameters such as the key information necessary for the encryption communication by the IPsec can be shared between the encryption communication module 100-C on the user terminal side and the encryption communication module 100-S on the service providing server side. Therefore, the encryption communication module 100-C on the user terminal side encrypts the first data packet received from the user terminal side application 110-C and sends it to the encryption communication module 100-S on the service providing server side 100-S through the user terminal side NAPT router 130-C and the service providing server side NAPT router 130-S. The service providing server side NAPT router 130-S decrypts the data packet encrypted to the IP packet of the plain text and delivers it to the application 110-S on the service providing server side (step 1151).

As a result of the processing described above, the encryption communication by IPsec becomes thereafter possible between the application 100-C on the user terminal side and the application 110-S on the service providing server side (step 1160).

FIG. 12 is a sending/receiving sequence diagram when the encryption communication line is established between UAC and UAS with the communication starting request from the UAC side application to the communication module as a start and the encryption communication is started.

First, the encryption communication module 100-S on the service providing server (UAS) side sends the location registration request message to the authentication/key exchange server 170 in the same way as step 1111 in FIG. 11 (step 1211). Receiving this message, the authentication/key exchange server 170 executes a similar processing as in step 1112 in FIG. 11 and returns the location registration response message to the encryption communication module 100-S on the service providing server side (step 1212).

Next, the application 110-C on the user terminal side requests to start communication for the encryption communication module 100-C on the user terminal side by using URI representing the service provided by the service providing server it has by itself (step 1221). Receiving the communication starting request, the encryption communication module 100-C on the user terminal side sends the communication starting request message inclusive of URI and the key information to the authentication/key exchange server 170 (step 1222). This message reaches finally the encryption communication module 100-S on the service providing server side in the same way as in step 1141 in FIG. 11. Receiving this message, the encryption communication module 100-S on the service providing server side sends the corresponding communication starting request response message inclusive of the key information to the authentication/key exchange server 170 (step 1223). This message reaches the encryption communication module 100-C on the user terminal side in the same way as in step 1142 in FIG. 11. Receiving this message, the encryption communication module 100-C on the user terminal side receives the response to the communications starting request and reports completion of the establishment of the encryption communication route to the application 110-C on the user terminal side (step 1224).

Subsequently, the application 110-C on the user terminal side sends the first data packet to the application 110-S on the service providing server side by using the IPsec encryption communication line so established (step 1231). Sending of this data packet is carried out in the same way as in step 1121 and step 1151 in FIG. 11 and finally, the data packet reaches the application 110-S on the service providing server side.

As a result of the processing described above, the encryption communication by IPsec becomes thereafter possible between the application 100-C on the user terminal side and the application 110-S on the service providing server side (step 1240).

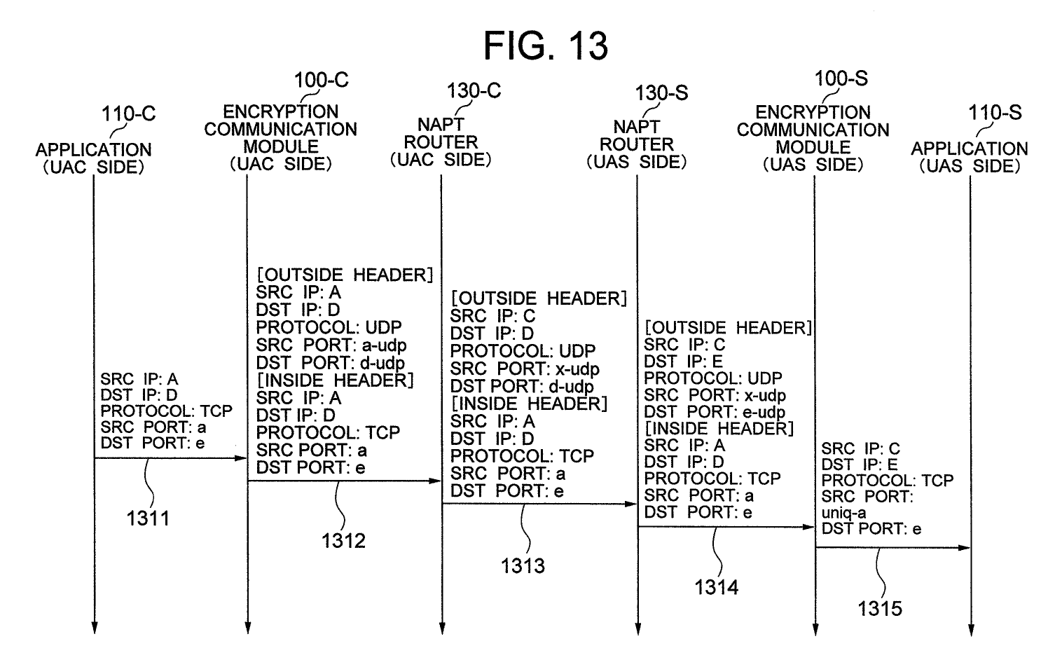

FIG. 13 is a sending/receiving sequence diagram when the encryption communication line is established between UAC and UAS and the data packet is then sent from the UAC side application to the UAS side application by using the encryption communication line.

First data packet sending/forwarding (steps 1121, 1151) in FIG. 11, first data packet sending (step 1231) in FIG. 12 and data communication from the user terminal to the service providing server in the application data communication (steps 1160, 1240) in FIGS. 11 and 12 that are directed from the user terminal to the service providing server are all executed in accordance with the sequence shown in FIG. 13.

First, the user terminal side application 110-C sends the data packet that is not encrypted and is in the form of the IP packet to the application 110-S on the service providing server side (step 1311). The source IP address of the IP header of the packet is at this time the private IP address allocated to the user terminal 120-C (here, IP address A in FIG. 1), the destination IP address is the global IP address allocated to the NAPT router on the service providing server side (here, IP address D in FIG. 1) and the protocol number is a value in accordance with the application protocol (here, TCP). At this time, the source port number of the TCP•UDP header (here, TCP header) and its destination port number are those port numbers which the application 110-C on the user terminal side recognizes (here, port umbers a and e in FIG. 1).

Next, the encryption communication module 100-C on the user terminal side receives this non-encrypted IP packet, applies encryption to constitute an IPsec tunnel mode form packet with UDP header and sends it from the network interface of the user terminal 120-C (step 1312). The source IP address and the destination IP address of the outside IP header of the packet at this time are the same as the source IP address and the destination IP address of the original IP packet not encrypted (here, IP addresses A and D). The source port number of the outside UDP header of the packet at this time is the number that the encryption communication module 100-C on the user terminal side recognizes as the port side of this side itself (here, port number a-udp in FIG. 1) and the destination port number is the port number of the encryption communication module 100-C on the service providing server side that is reported from the encryption communication module 100-C on the service providing server side to the encryption communication module 100-C on the user terminal side through the authentication/key exchange server 170 (here, port number d-udp). The inside IP packet is created by encrypting the packet entirely the same as the non-encrypted IP packet in step 1311 inclusive of the IP header and the TCPUDP header.

Next, the NAPT router 130-C on the user terminal side receives the encrypted IPsec tunnel mode form packet with UDP header from the LAN side interface, rewrites the source IP address of the outside IP header and the source port number of the outside UDP header and sends the packet from the WAN side interface (step 1313). At this time, the source IP address of the outside IP header of the packet is rewritten to the global IP address allocated to the WAN side interface of the NAPT router 130-C on the user terminal side (here, IP address C in FIG. 1) and the source port number of the outside UDP header is rewritten to a port number appropriately allocated by the NAPT router 130-C on the user terminal side (here, port number x-udp).

Next, the NAPT router 130-S on the service providing server side receives the encrypted IPsec tunnel mode form packet with UDP header from the WAN side interface, rewrites the destination IP address of the outside IP header and the destination port number of the outside UDP header and sends the packet from the LAN side interface (step 1314). At this time, the destination IP address of the outside IP header of the packet is rewritten to the private IP address allocated to the service providing server 120-S (here, IP address E in FIG. 1) and the destination port number of the outside UDP header is rewritten to a port number that the encryption communication module 100-S on the service providing server side recognizes as the port number of its own (here, port number e-udp in FIG. 1). Incidentally, this rewrite operation is carried out on the basis of the static NAPT translation rule set in advance to the NAPT router 130-S on the service providing server side.

Finally, the encryption communication module 100-S on the service providing server side receives the encrypted IPsec tunnel mode form packet with UDP header from the network interface of the service providing server 120-S, decrypts the inside IP packet to take out the non-encrypted original IP packet, rewrites the source IP address and the destination IP address of the IP header of the packet and the source port number of the TCP•UDP header of the packet and hands over the packet to the application 110-S on the service providing server side (step 1315). At this time, the source IP address and its destination IP address of the IP header of the packet use the values of the outside IP header of the original IPsec tunnel mode form packet with UDP header. The value of a port number allocated by the encryption communication module 100-S on the service providing server side so that the other-side IP address of the outside header takes a unique value in the same entry in the SP table (here, port number uniq-a) is used for the source port number of the TCP•UDP header of the packet.

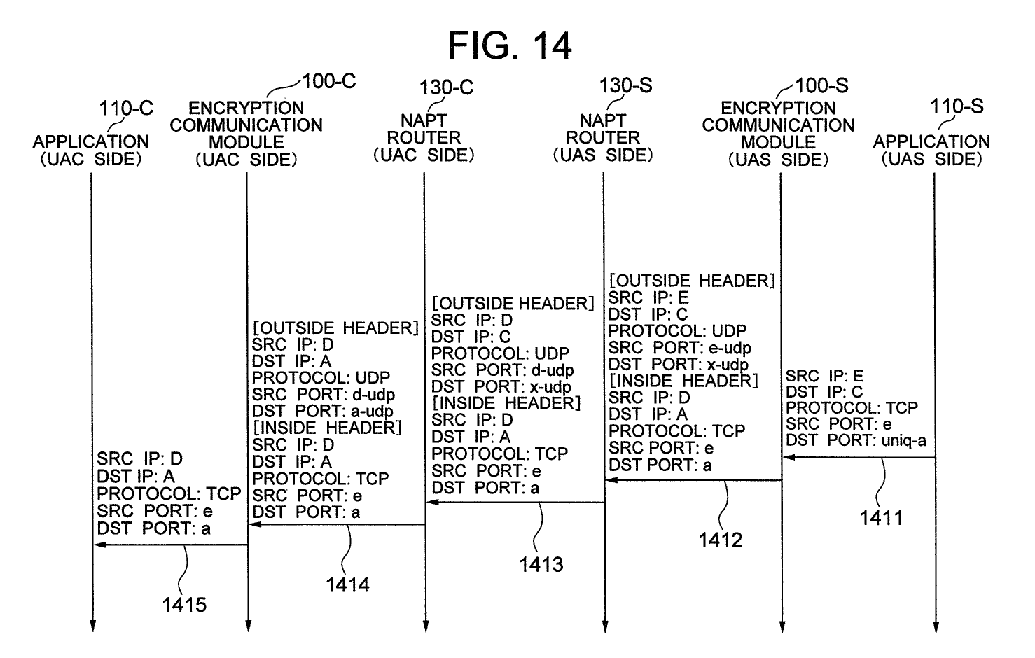

FIG. 14 is a sending/receiving sequence diagram when the encryption communication line is established between UAC and UAS and the data packet is then sent from the UAS side application to the UAC side application by using the encryption communication line.

The application data communication from the service providing server to the user terminal among those shown in FIGS. 11 and 12 (steps 1160 and 1240) is carried out in accordance with the sequence diagram of FIG. 14.

First, the application 110-S on the service providing server side sends the data packet in the form of the non-encrypted IP packet to the application 110-C on the user terminal side (step 1411). The source IP address of the IP header of the packet is at this time the private IP address allocated to the service providing server 120-S (here, IP address E in FIG. 1), the destination IP address is the global IP address allocated to the NAPT router on the user terminal side (here, IP address C in FIG. 1) and the protocol number is a value in accordance with the application protocol (here, TCP). At this time, the source port number of the TCP•UDP header (here, TCP header) is the port number which the application 110-S on the service providing server side recognizes (here, port number e). The destination port number is the port number of the application 110-C on the user terminal side (here, port number uniq-a) when the application 110-S on the service providing server side first receives the data packet from the application 110-C on the user terminal side (step 1315 in FIG. 13).

Next, the encryption communication module 100-S on the service providing server side receives this non-encrypted IP packet, rewrites the IP header and the TCP•UDP header of the IP header of the inside IP packet as will be later described, applies encryption to constitute an IPsec tunnel mode form packet with UDP header and sends it from the network interface of the service providing server 120-S (step 1412). The source IP address and the destination IP address of the outside IP header of the packet at this time are the same as the source IP address and the destination IP address of the original IP packet not encrypted (here, IP addresses E and C). The source port number of the outside UDP header of the packet at this time is the number that the encryption communication module 100-S on the service providing server side recognizes as the port side of this side itself (here, port number e-udp in FIG. 1) and the destination port number is the port number of the encryption communication module 100-C on the user terminal side known (step 1314 in FIG. 13) when the encryption communication module 100-S on the service providing server side first receives the data packet arrived from the encryption communication module 100-C on the user terminal side (here, port number x-udp). The same values as the destination IP address and the source IP address of the IP header and the source port number of the TCP•UDP header of the inside IP packet when the encryption communication module 100-S on the service providing server side receives (step 1314 in FIG. 13) the data packet arrived from the encryption communication module 100-C on the user terminal side (here, IP address D, IP address A, port number a), respectively are set to the source IP address and the destination IP address of the IP header and to the destination port number of the TCP•UDP header of the inside IP packet, respectively.

Next, the NAPT router 130-S on the service providing server side receives the encrypted IPsec tunnel mode form packet with UDP header from the LAN side interface, rewrites the source IP address of the outside IP header and the source port number of the outside UDP header and sends the packet from the WAN side interface (step 1413). At this time, the source IP address of the outside IP header of the packet is rewritten to the global IP address allocated to the WAN side interface of the NAPT router 130-S on the service providing server side (here, IP address D in FIG. 1) and the source port number of the outside UDP header is rewritten to a port number based on the static NAPT translation rule set in advance to the NAPT router 130-S on the service providing server side (here, port number d-udp).

Next, the NAPT router 130-C on the user terminal side receives the encrypted IPsec tunnel mode form packet with UDP header from the WAN side interface, rewrites the destination IP address of the outside IP header and the destination port number of the outside UDP header and sends the packet from the LAN side interface (step 1414). At this time, the destination IP address of the outside IP header of the packet is rewritten to the private IP address allocated to the user terminal 120-SC (here, IP address A in FIG. 1) and the destination port number of the outside UDP header is rewritten to a port number that the encryption communication module 100-C on the user terminal side recognizes as the port number of its own (here, port number a-udp in FIG. 1). Incidentally, this rewrite operation is carried out on the basis of the dynamic NAPT translation rule generated when the NAPT router 130-C on the user terminal side receives (step 1312 in FIG. 13) the data packet arrived from the encryption communication module 100-C on the user terminal side.

Finally, the encryption communication module 100-C on the user terminal side receives this encrypted IPsec tunnel mode form packet with UDP header from the network interface of the user terminal 120-C, decrypts the inside IP packet to take out the non-encrypted original IP packet and hands over the packet to the application 110-C on the user terminal side (step 1415). At this time, rewrite of the IP header and the TCP•UDP header is not at all executed for the inside IP packet decrypted and the packet is as such handed over to the application 110-C on the user terminal side.

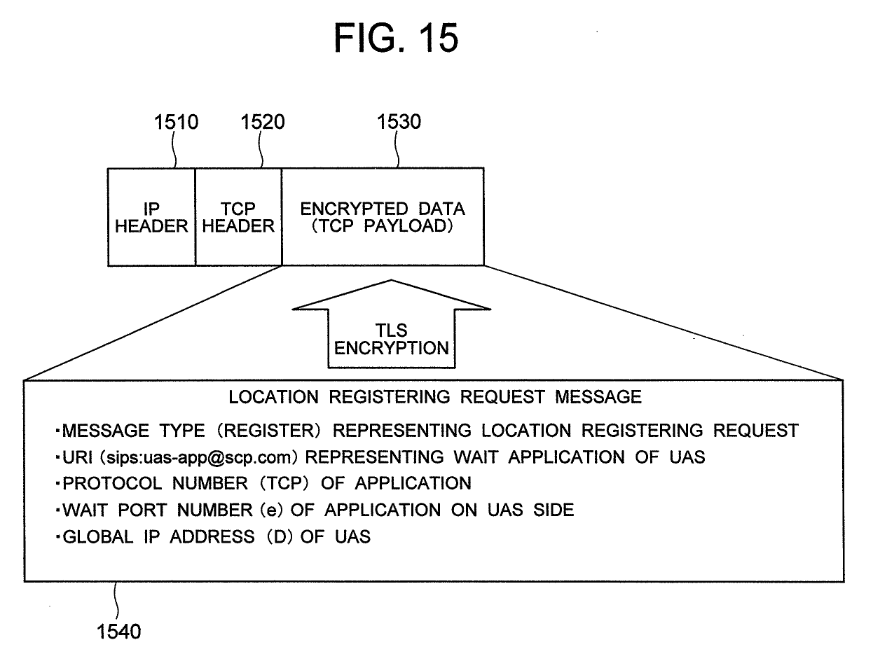

FIG. 15 shows a data structure of a location registration request message in the first embodiment.

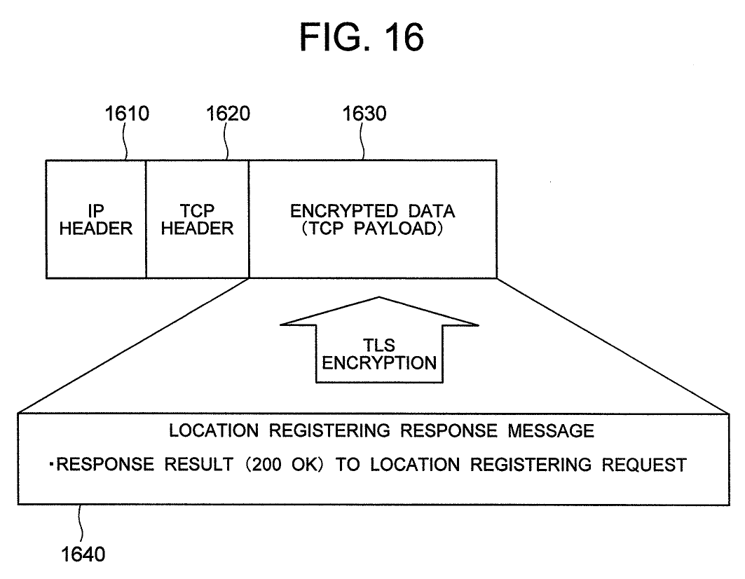

In this embodiment, the location registration request message is materialized as an SIP message for which encryption is made by TLS. However, the invention can be executed as long as a message containing data having an equivalent content can be sent and received to and from the encryption communication module 100 without using TLS and SIP. This also holds true of the later-appearing FIGS. 16 through 20.

The location registration request message includes an IP header 1510, a TCP header 1520 and encrypted data 1530. Though the drawing assumes the case where one message is accommodated in one IP packet but when the portion of the encrypted data is long, the message is divided in some cases into a plurality of IP packets. This is processed in accordance with the TLS and TCP standard and also holds true of the later-appearing FIGS. 16 through 20.

The encrypted data 1530 is generated by encrypting a location registration request message main body 1540 by TLS. The location registration request message main body 1540 is constituted in accordance with an SIP protocol. Here, only main information contained in this message main body will be illustrated. The patent document 1 represents a more concrete method of realizing the message main body using the SIP protocol. This also holds true of the later-appearing FIGS. 16 through 20.

The location registration request message main body 1540 contains information such as a message type representing a location registration request, a URI representing a representing a wait application of the service providing server, a protocol number of the application, a wait port number of the application on the service providing server side and a global IP address of the service providing server. These kinds of information are constituted in accordance with the content of the location information 101.

FIG. 16 shows a data structure of the location registration response message in the first embodiment.

A location registration response message main body 1640 contains information representing the response result to the location registration request.

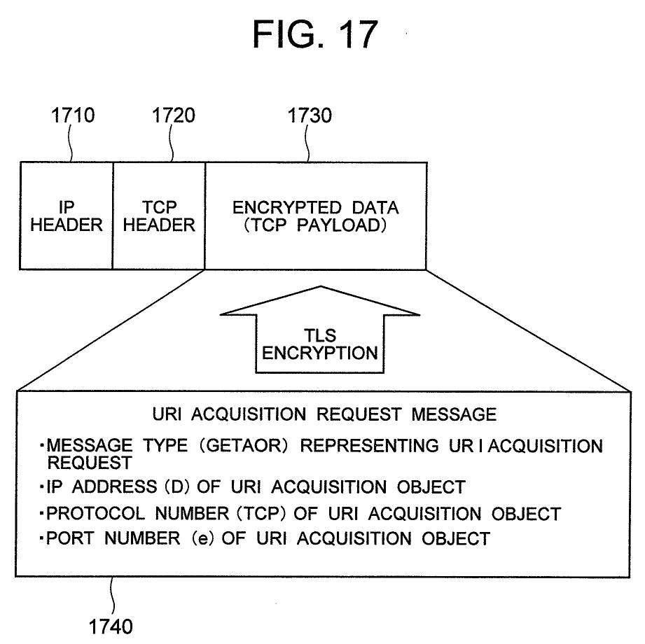

FIG. 17 shows a data structure of a URI acquisition request message in the first embodiment.

The URI acquisition request message main body 1740 contains information such as a message type representing a URI acquisition request, an IP address of a URI acquisition object, a protocol number of the URI acquisition object and a port number of the URI acquisition object. These kinds of information are constituted in accordance with the content of the IP header and the TCP•UDP header of the first data packet (step 1121 in FIG. 11) that the encryption communication module 100-C on the user terminal side receives from the application 110-C on the user terminal side.

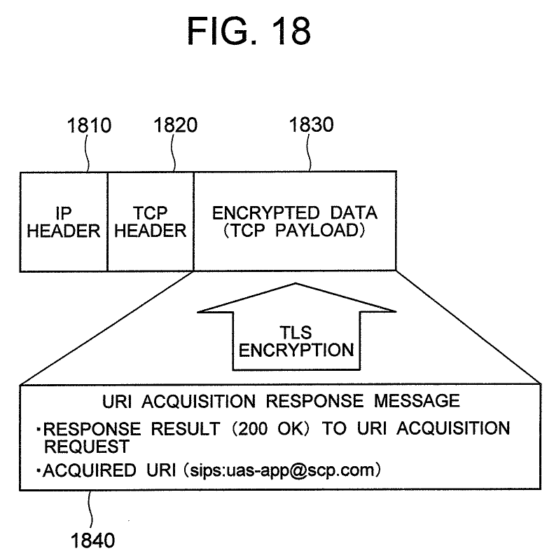

FIG. 18 shows a data structure of a URI acquisition response message in the first embodiment.

A URI acquisition response message main body 1840 contains information such as the response result to the URI acquisition request and the URI acquired.

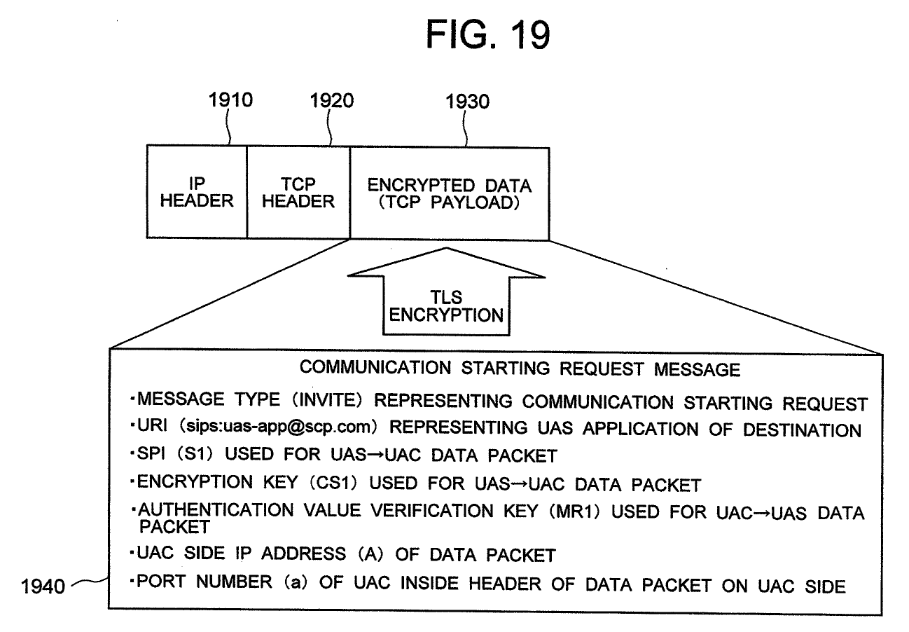

FIG. 19 shows a data structure of a communication starting request message in the first embodiment.

A communication starting request message main body 1940 contains information such as a message type representing a communication starting request, a URI representing an application on the service providing server side of the destination side, an encryption key used for encrypting the data packet, a authentication value verification key that is used for verifying whether or not an authentication value contained in the data packet is correct, SPI corresponding to these kinds of key information, an IP address of the data packet on the user terminal side and a port number of the inside header of the data packet on the user terminal side. Entries of the SP table 103, the reception SA table 104 and the transmission SA table 105 are generated on both user side and service providing server side on the basis of these kinds of information (other than URI).

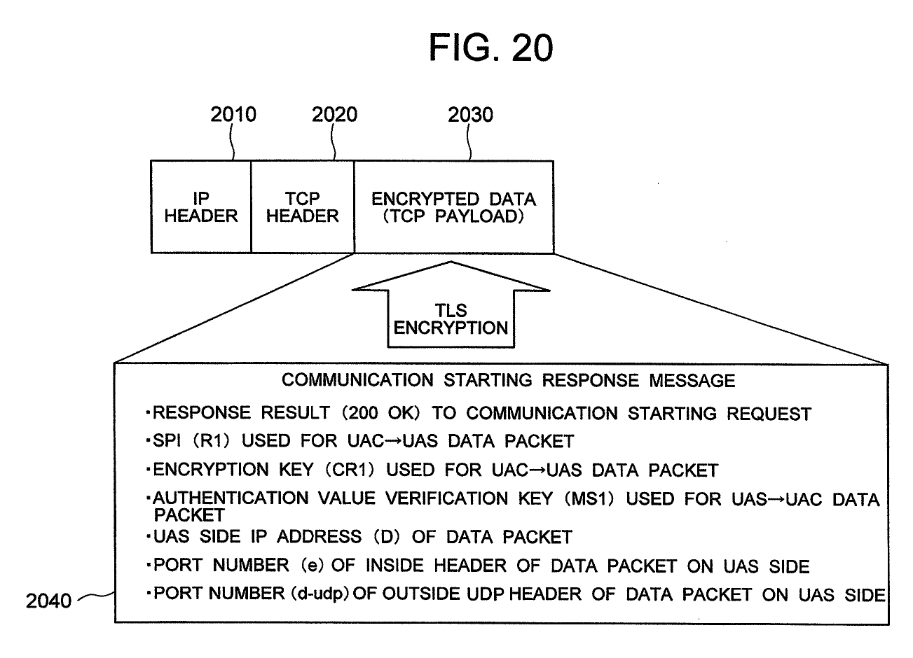

FIG. 20 shows a data structure of a communication starting request response message in the first embodiment.

A communication starting response message main body 2040 contains information such as the response result to the communication starting request, the encryption key used for encrypting the data packet, a authentication value verification key for verifying whether or not the authentication value contained in the data packet is correct, SPI corresponding to these kinds of key information, an IP address of the data packet on the service providing server side, a port number of the inside header of the data packet on the service providing server side and a port number of the outside UDP header of the data packet on the service providing server side. Entries of the SP table 103, the reception SA table 104 and the transmission SA table 105 are generated on both user side and service providing server side on the basis of these kinds of information.

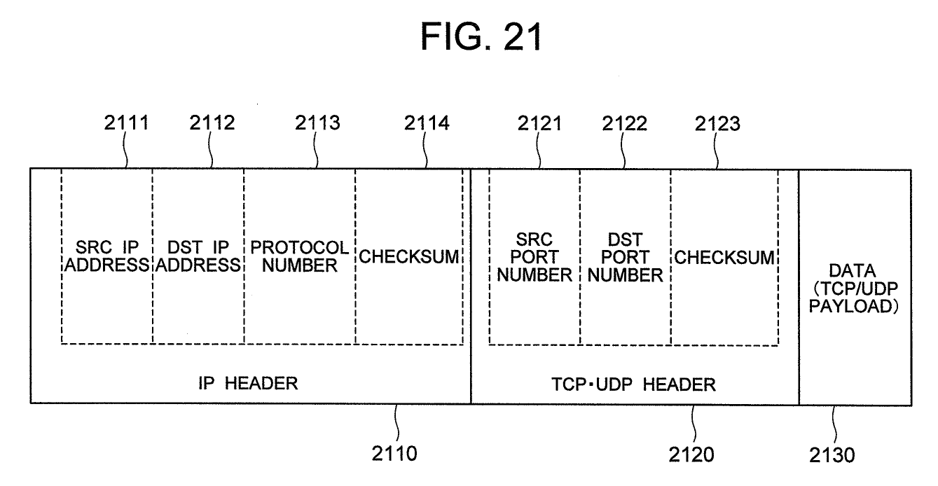

FIG. 21 shows a data structure of a non-encrypted IP packet in the first embodiment.

It will be assumed in the IP packet used by the application for communication in the invention that TCP or UDP is used as a high order layer protocol of the IP. In other transport layer protocols having a source port number and a destination port number and capable of applying NAPT, too, the invention is applicable in the same way as TCP and UDP. The description will discuss only the case where TCP or UDP is used.

The IP packet includes an IP header 2110 and an IP payload. The IP payload includes a TCP•UDP header 2120 and a TCP•UDP payload 2130.

The IP header 2110 contains a field of each of a source IP address 2111, a destination IP address 2112, a protocol number 2113 and a checksum 2114. Generally, fields other than those described above are contained.

The IP address of the source of the IP packet is stored in the source IP address 2111. The IP address of the destination of the IP packet is stored in the destination IP address 2112. The protocol number of the high order layer protocol of the IP is stored in the protocol number 2113. The checksum value calculated from the IP header is stored in the checksum 2114. Generally, in the IP processing receiving the IP packet in which this checksum value is wrong, the packet is discarded. Therefore, when the information contained in the IP header such as the source IP address 2111 and the destination address 2112 is rewritten, the checksum 2114 must be calculated again.

The TCP•UDP header 2120 contains each field of the source port number 2121, the destination port number 2122 and the checksum 2123. Needless to say, other fields are generally contained.

The port number of the source of the TCP•UDP packet is stored in the source port number 2121. The port number of the destination of the TCP•UDP packet is stored in the destination port number 2122. The checksum value calculated from the whole TCP•UDP packet (both of header and payload) is stored in the checksum 2123. Generally, in the TCP•UDP processing receiving this TCP•UDP packet in which this checksum value is wrong, the packet is discarded. Therefore, when the information contained in the TCP•UDP header such as the source port number 2121 and the destination port number 2122 is rewritten, the checksum 2123 must be calculated again. In the case of UDP, however, 0 of the value representing omission of the checksum calculation in the checksum field 2123 is permitted.

The data main body of TCP or UDP is stored in the TCP•UDP payload 2130.

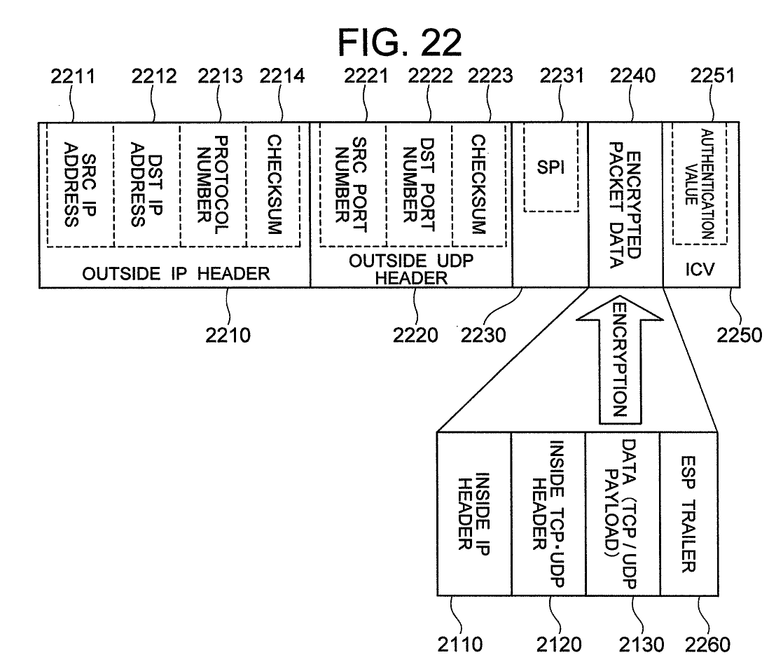

FIG. 22 shows a data structure of an encrypted IPsec tunnel mode form packet with UDP header in the first embodiment.

The IPsec tunnel mode form packet with UDP header includes an outside IP header 2210, an outside UDP header 2220, an ESP (Encapsulating Security Payload) header 2230, an encrypted packet data 2240 and ICV (Integrity Check Value) 2250.

The construction of each of outside IP header 2210 and the outside UDP header 2220 is the same as the construction of each of the IP header 2110 and the UDP header 2120 shown in FIG. 21. The ESP header 2230 contains the field of SPI 2231. The ICV 2250 contains the field of the authentication value 2251. When HMAC is used for the authentication algorithm of the packet data, for example, the field of the authentication value 2251 store MAC (Message Authentication Code) calculated on the basis of the ESP header 2230 and the encrypted packet data 2240.

The encrypted packet data 2240 is generated by adding an ESP trailer 2260 to the tail of the IP packet before encryption and encrypting the IP packet. The IP packet before encryption has entirely the same data structure as that of the IP packet shown in FIG. 21.

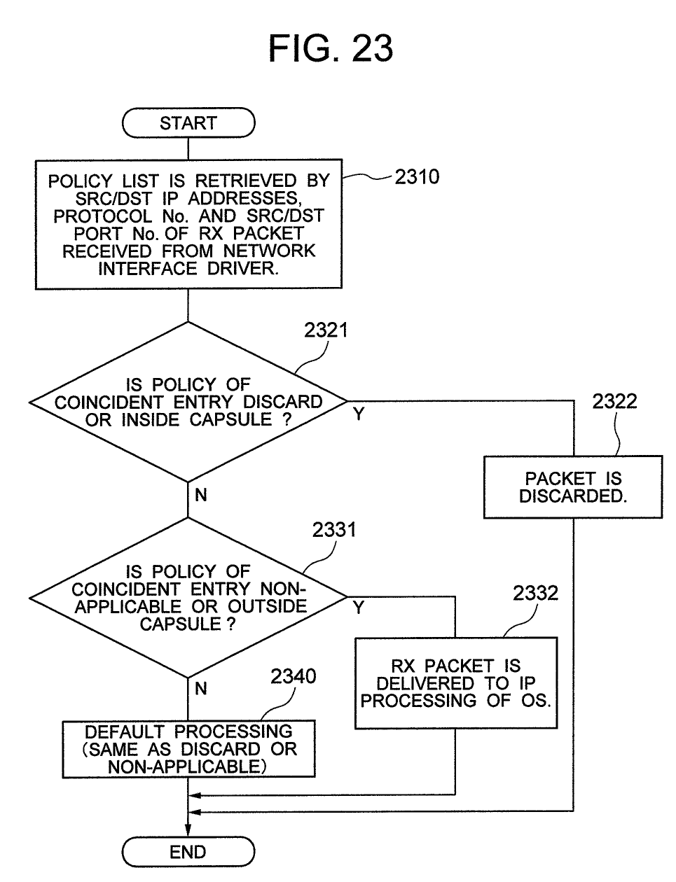

FIG. 23 is a flowchart of a decision to apply capsulation processing executed when the encryption communication module having the communication method of the invention receives the receipt packet from the network interface driver in the first embodiment.

This algorithm is executed when the decision 301 to apply encapsulation processing inside the encryption communication module 100 receives the receipt packet from the network interface driver 320.

Receiving the receipt packet from the network interface driver 320, the decision 301 to apply encapsulation processing compares the source IP address, the destination IP address, the protocol number, the source port number and the destination port number of the receipt packet with the other-side IP address 521, this-side (private) IP address 541, the protocol number 510, the other-side port number 522 and this-side (private) port number 542 of the policy list 102, respectively, to retrieve the policy list 102 (step 2310).

When the coincident entry is found out and the policy 550 of the entry is discarded or inside the capsule (step 2321), the receipt packet is discarded (step 2322) and the processing is finished.

When the coincident entry is found out and the policy 550 of the entry is not applicable or outside capsule (step 2331), the receipt packet is handed over to the IP processing 311 of the OS (step 2332) and the processing is finished.

When the coincident entry is not found out, a processing that is the same as discard or non-application is executed as a default processing (step 2340) and the processing is finished. Which of the discard and non-application should be employed as the default processing is different depending on which security policy the system is to be operated.

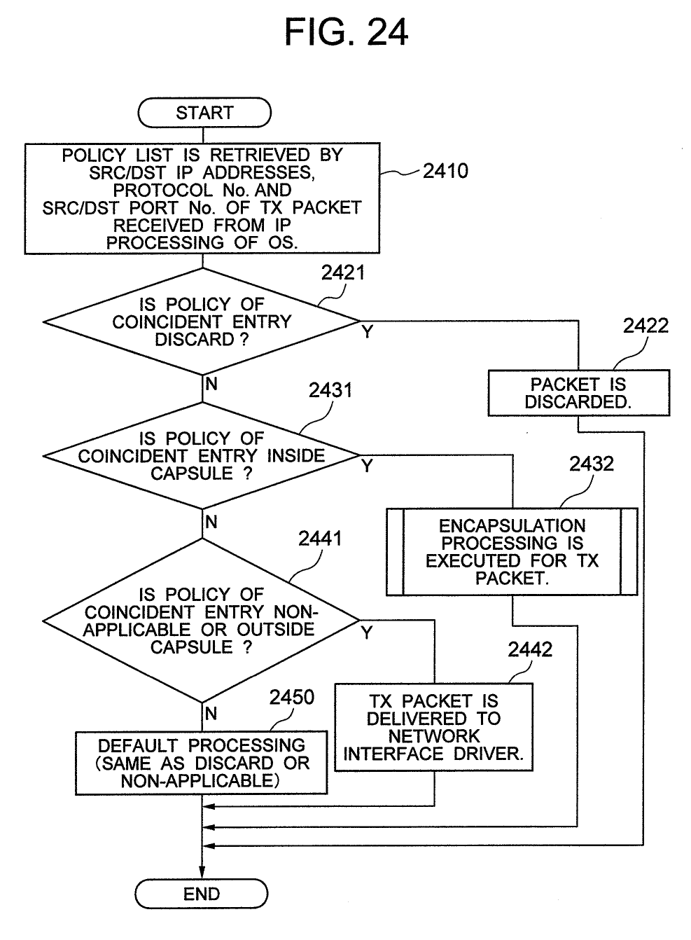

FIG. 24 is a flowchart showing the flow of the decision to apply encapsulation processing that is executed when the encryption communication module having the communication method of the invention receives the transmission packet from the IP processing of the OS in the first embodiment.

This algorithm is executed when the decision 301 to apply encapsulation processing inside the encryption communication module 100 receives the transmission packet from the IP processing 311 of the OS.

Receiving the transmission packet from the IP processing 311 of the OS, the decision 301 to apply encapsulation processing compares the source IP address, the destination IP address, the protocol number, the source port number and the destination port number of the transmission packet with this-side (private) IP address 541, the other-side IP address 521, the protocol number 510, this-side (private) port number 542 and the other-side port number 522 of the policy list 102, respectively, to retrieve the policy list 102 (step 2410).

When the coincident entry is found out and the policy 550 of the entry is discarded or inside the capsule (step 2421), the transmission packet is discarded (step 2422) and the processing is finished.

When the coincident entry is found out and the policy 550 of the entry is inside the capsule (step 2431), the encapsulation processing 303 is executed for the transmission packet (step 2432) and the processing is finished.

When the coincident entry is found out and the policy 550 of the entry is not applicable or outside capsule (step 2441), the transmission packet is handed over to the network interface driver 320 (step 2442) and the processing is finished.

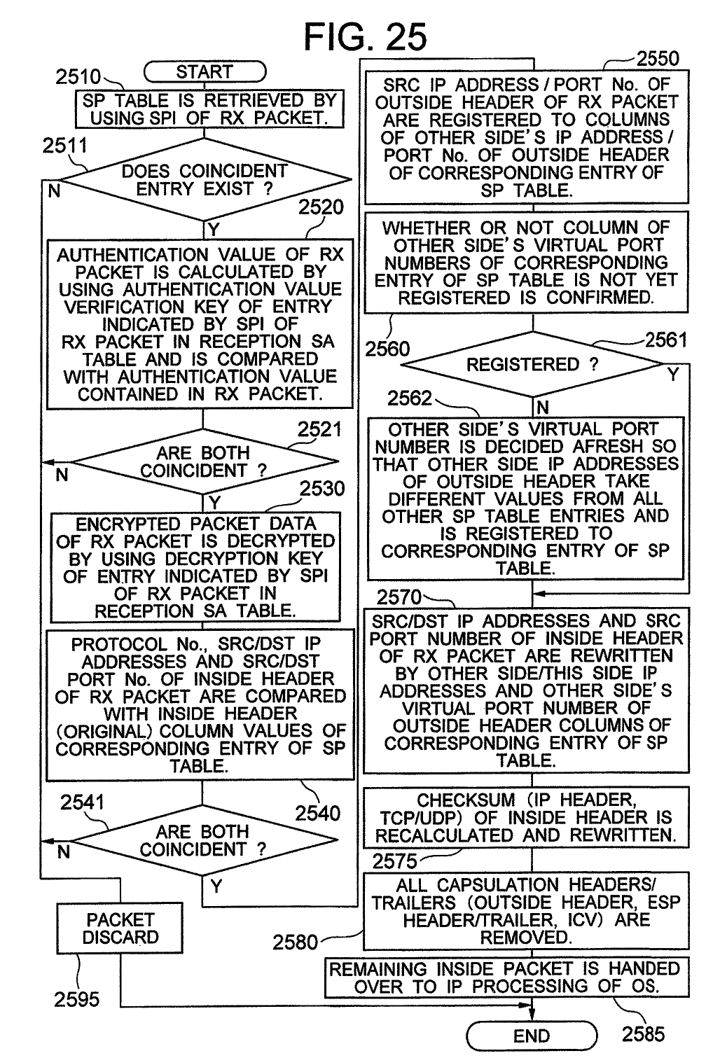

When the coincident entry is not found out, a processing that is the same as discard or non-application is executed as a default processing (step 2450) and the processing is finished. Which of the discard and non-application should be employed as the default processing is different depending on which security policy the system is to be operated. FIG. 25 is a flowchart showing the flow of the decapsulation processing that is executed when the encryption communication module having the communication method of the invention receives the receipt packet from the UDP processing of the OS.

This algorithm is executed when the decapsulation processing 302 inside the encryption communication module 100 receives the receipt packet from the UDP processing 313 of the OS.

Receiving the receipt packet from the UDP processing 303 of the OS, the decapsulation processing 302 compares the SPI 2231 contained in the receipt packet with the reception SPI 640 of the SP table 103 to retrieve the SP table 103 (step 2510). As a result, the packet is discarded (step 2595) when the coincident entry is not found out (step 2511) and the processing is finished.

When the coincident entry is found out, the SPI 2231 contained in the receipt packet is compared this time with the reception SPI 710 of the reception SA table 104 to retrieve the reception SA table 104 and to acquire the encryption key 720 and the authentication value verification key 730 that correspond to the SPI. The authentication value of the receipt packet is calculated by using this authentication value verification key 730 and whether or not it is coincident with the authentication value 2251 contained in the receipt packet is confirmed (step 2520). When these values are not coincident (step 2521), the packet is discarded (step 2595) and the processing is finished.

When the authentication value is coincident, the encrypted packet data 2240 inside the receipt packet is decrypted by using the decryption key 720 previously acquired and an inside IP packet of the plain text is obtained (step 2530). The protocol number, the source IP address and the destination IP address contained in the IP header 2110 of this inside IP packet and the source port number and the destination port number contained in the TCP•UDP header 2120 are compared with the protocol number 621, the other side IP address 622, this side IP address 624, the other side port number 623 and this side port number 625 of the inside header (original) 620 contained in the entry of the SP table found out by the previous retrieval, respectively, to confirm whether or not all them are coincident (step 2540). If any item that is not coincident is found out (step 2541), the packet is discarded (step 2595) and the processing is finished.

When these values are coincident, the values of the source IP address of the outside IP header 2210 and the source port number of the outside UDP header 2220 of the receipt packet are set to the items of the other-side IP address 611 and the other-side port number 612 of the entries of the SP table previously found out by retrieval, respectively (Step 2550).

Next, whether or not the item of the other-side virtual port number of the entry of the SP table previously found out by the retrieval is not yet registered is examined (step 2560). When it is not registered (step 2561), the other-side virtual port number 630 is decided afresh so that the other-side IP address 611 of the outside header 610 is different from all the other SP table entries, and this port number is then registered to the corresponding entry of the SP table (step 2562).

Next, the source IP address and the destination IP address of the inside IP header and the source port number of the inside TCP•UDP header of the receipt packet are rewritten by the other-side IP address 611 and this-side IP address 613 of the outside header 610 of the corresponding entry of the SP table and the other-side virtual port number 630 (step 2570) and the checksum 2114 of the inside IP header and the checksum 2123 of the inside TCP•UDP header are calculated again, whenever necessary, and re-write is made by the re-calculation value (step 2575).

Then, the outside IP header 2210, the outside UDP header 2220, the ESP header 2230, the ESP trailer 2260 and ICV 2250 are all removed from the receipt packet (step 2580), the remaining inside IP packet is handed over to the IP processing 311 of the OS (step 2585) and the processing is finished.

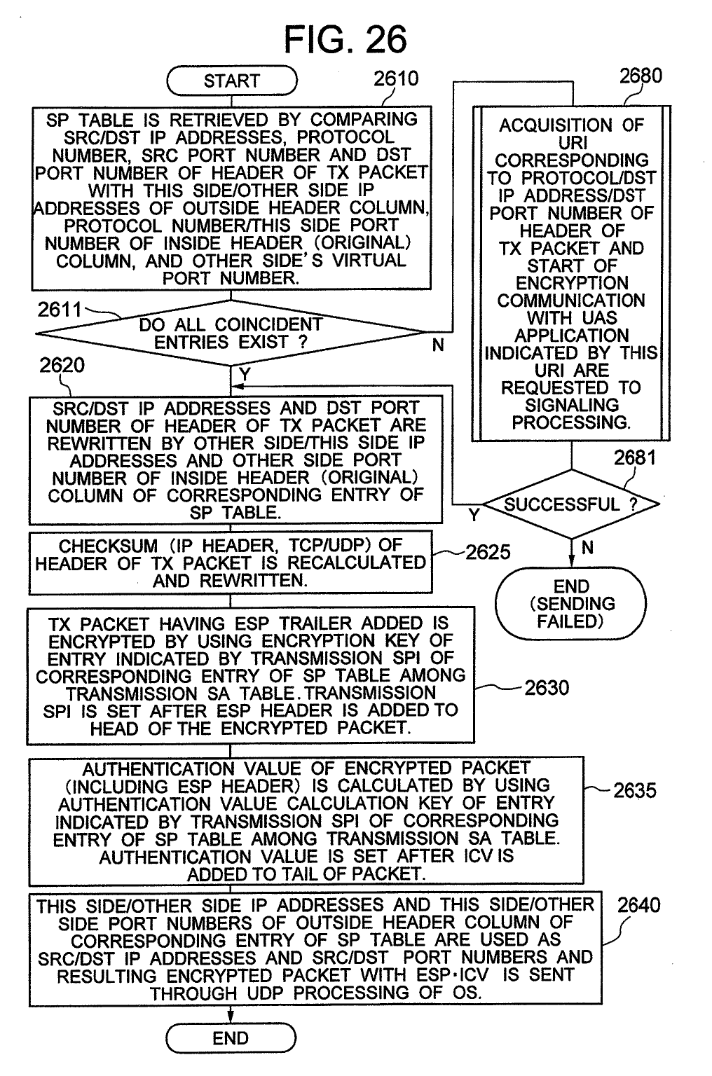

FIG. 26 is a flowchart showing the flow of an encapsulation processing of the transmission packet called from the decision to apply capsulation processing of the encryption communication module having the communication method of the invention in the first embodiment.

This algorithm is executed when the decision to apply capsulation processing 301 inside the encryption communication module 100 judges the transmission packet received from the IP processing 311 of OS as “inside capsule”.

Receiving the transmission packet from the decision to apply capsulation processing 301, the encapsulation processing 303 compares the source IP address, the destination IP address and the protocol number of the IP header 2110 and the source port number and the destination port number of the TCP•UDP header 2120 of the transmission packet with the this-side IP address 613 and the other-side IP address 611 of the outside header 610 and the protocol number 621 and this-side port number 625 of the inside header (original) 620 and the other-side virtual port number 630 of the SP table 103, respectively, to retrieve the SP table 103 (step 2610).

As a result, when the coincident entry does not exist (step 2611), acquisition of the protocol number and the destination IP address of the IP header 2110 and the URI corresponding to the destination port number of the TCP•UDP header 2120 of the transmission packet and starting of encryption communication with the application 110-S on the service providing server side represented by this URI are requested for the signaling processing 304 (step 2680). As a result, when the start preparation of encryption communication fails (step 2681), the processing is finished as sending of the packet fails. The following processing is continued when the start preparation is successful.

Next, the source IP address and the destination IP address of the IP header 2110 and the destination port number of the TCP•UDP header 2120 of the transmission packet are rewritten (step 2620) by the values of this-side IP address 624, the other-side IP address 622 and the other-side port number 623 of the inside header (original) 620 of the corresponding entry (coincident entry when it is found out in step 2610 and entry created afresh in step 2680 when coincident entry is not found out). The checksum 2114 of the IP header and the checksum 2123 of the TCP•UDP header are calculated again, whenever necessary, and rewrite is made by the re-calculation values (step 2625).

Next, the entry in which the transmission SPI of the corresponding entry of the SP table 103 is coincident with the value of the transmission SPI is searched from the transmission SA table 105 to acquire the encryption key 820 and the authentication value calculation key 830 of this entry. The transmission packet to which the ESP trailer 2260 is added is encrypted by using this encryption key 820. The ESP header 2230 is added to the leading part of the resulting encrypted packet data 2240 and the value of the transmission SPI 650 is set to the SPI field 2231 (step 2630).

The authentication value of the encrypted packet data 2240 to which the ESP header 2230 is added is then calculated by using the authentication value verification key 830 obtained previously. ICV 2250 is added to the tail of the encrypted packet data 2240 and the authentication value calculated is set to the authentication value field 2251 (step 2635).

This-side IP address 613, the this-side port number 614 and the other-side port number 612 of the outside header 610 of the corresponding entry of the SP table 103 are set to the source IP address, the destination IP address, the source port number and the destination port number, respectively, and the resulting encrypted packet (constituted by ESP header 2230, encrypted packet data 2240 and ICV 2250) is sent through the UDP processing 313 of the OS (step 2640). The processing is then finished.

### Second Embodiment

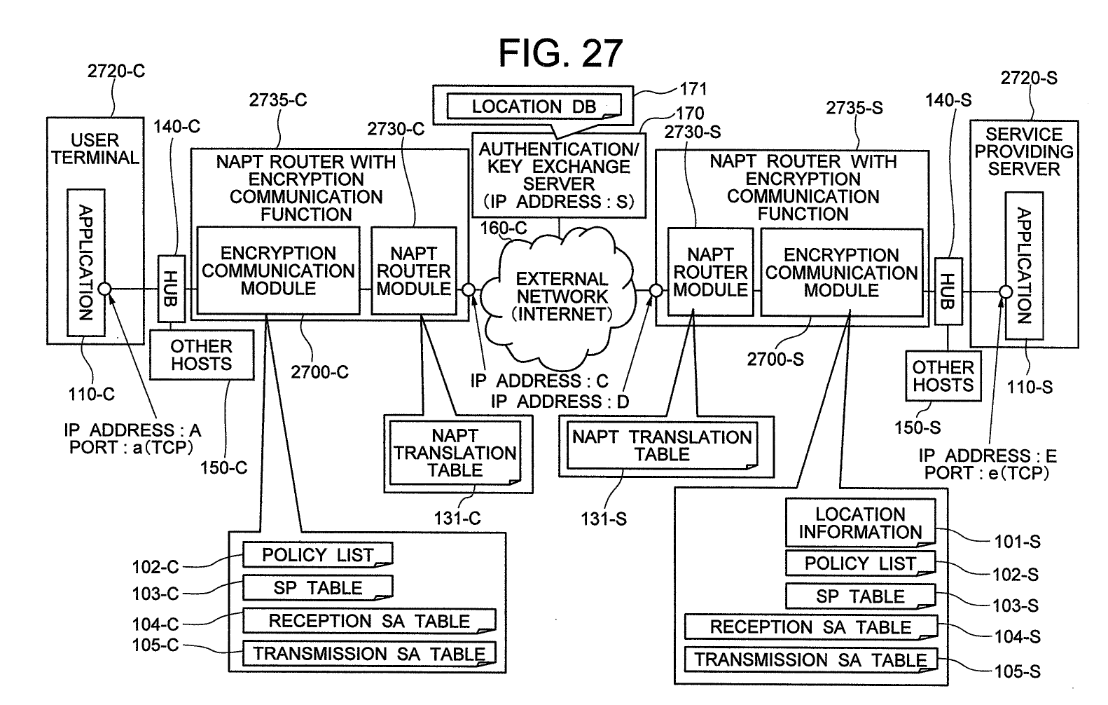

FIG. 27 shows a network construction of a system as an operation object of an encryption communication module having a communication method of the invention in a second embodiment of the invention.

In the second embodiment, the encryption communication modules 2700-C and 2700-S operate inside NAPT routers 2735-C and 2735-S with encryption communication function but not inside the user terminal 2720-C and the service providing server 2720-S. Inside the NAPT routers with encryption communication function 2735-C and 2735-S, encryption communication modules 2700-C and 2700-S operating similarly to the encryption communication modules 110-C and 100-S in the first embodiment and NAPT router modules 2730-C and 2730-S operating similarly to the NAPT routers 130-C and 130-S in the first embodiment operate inside the NAPT routers with encryption communication function 2735-C and 2735-S. Only applications 110-C and 110-S operate inside the user terminal 2720-C and the service providing server 2720.

In this embodiment, communication of the application is carried out in the form of the plain text as it is between the user terminal 2720-C/service providing server 2720-S and the NAPT routers with encryption communication function 2735-C, 2735-S. On the other hand, a plurality of user terminals not having the encryption communication function placed under the same NAPT router can encrypt the communication of the application in WAN by using only one NAPT router 2735-C with encryption communication function. This also holds true of the service providing server.

Incidentally, the method that places the encryption communication module in the user terminal and the service providing server shown in the first embodiment and the method that places the encryption communication module inside the NAPT router shown in the second embodiment can coexist as long as the method is unified to either one of them for each LAN. In other words, it is possible to employ the method that places the encryption communication module in the NAPT router on the user terminal side and the encryption communication module inside the service providing service on the service providing server side.

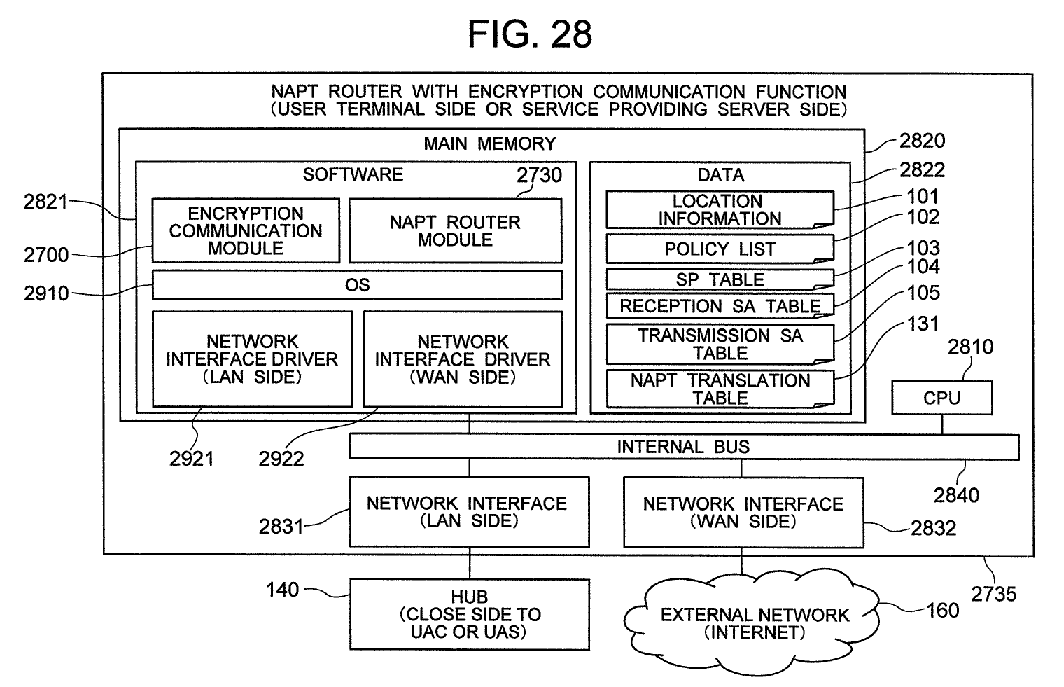

FIG. 28 shows an internal processing architecture of an NAPT router with encryption communication function in which the encryption communication module with the communication method of the invention operates in the second embodiment.

The NAPT router 2735 with encryption communication function has network interfaces 2831 and 2832 on the WAN side and the LAN side, respectively, and corresponding network interface drivers 2921 and 2922 operate, respectively. Because the embodiment has the NAPT router function but not the application, the NAPT router module 2730 operates in place of software of the application and an NAPT translation table 131 exists. The rest of constructions are substantially the same as those of the user terminal 2720-C and the service providing server 2720-S in the first embodiment.

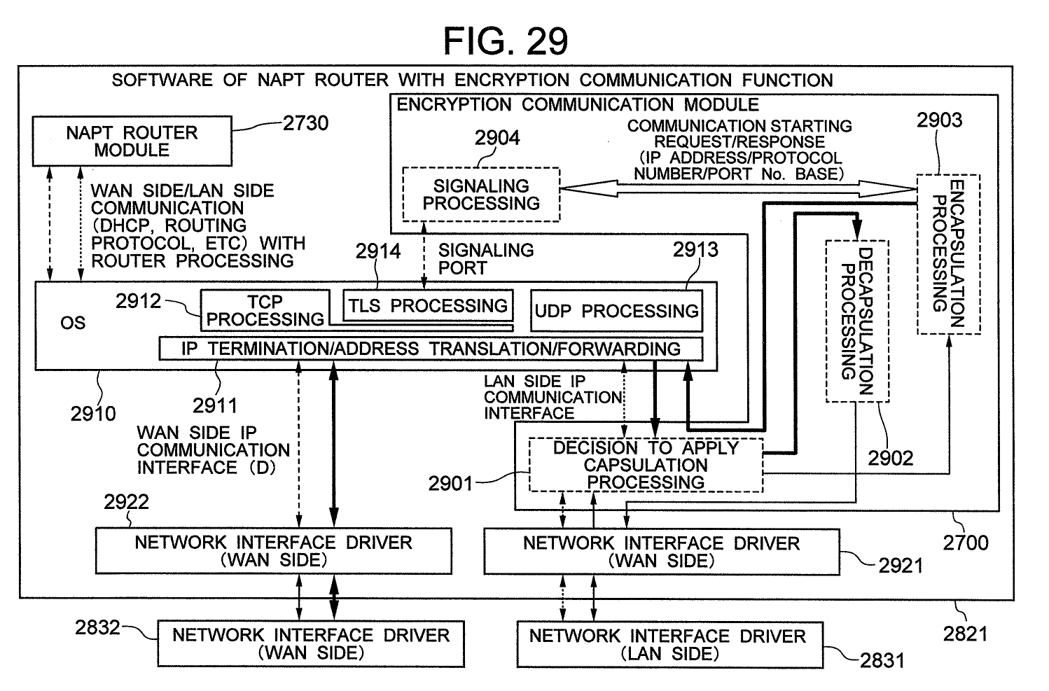

FIG. 29 shows a software construction of an NAPT router with encryption communication function including the encryption communication module having the communication method of the invention operates in the second embodiment.

Since the NAPT router with encryption communication function 2735 must be able to execute packet forwarding in the IP layer, an IP termination/address translation/forwarding process 2911 has not only a sending/receiving function of IP as an end host but also an IP packet relay function as a router. This NAPT router 2735 executes the NAPT processing for the forwarding packet in accordance with setting from the NAPT router module.

A decision to apply capsulation processing 2901 of the encryption communication module 2700 interposes between the IP communication interface of the IP termination/address translation/forwarding process 2911 corresponding to the network interface (LAN side) 2831 and the network interface driver (LAN side) 2921 corresponding to the network interface (LAN side) 2831 and judges whether or not the decapsulation processing 2902 or the encapsulation processing 2903 should be made for the IP packet forwarded or whether or not the packet should be handed over as such to the IP termination/address translation/forwarding process 2911 and the network interface driver (LAN side) 2921 without executing any process or should be discarded without processing. The processing is then executed in accordance with the judgment result.

The decapsulation processing 2902 receives, from the decision to apply capsulation processing 2901, the IPsec tunnel mode form packet whose decryption is judged as being necessary by the decision to apply capsulation processing 2901, confirms and decrypts the authentication value of the packet and delivers the inside plain text IP packet taken out to the network interface driver (LAN side) 2921.

The capsulation processing 2903 receives, from the decision to apply capsulation processing 2901, the plain text IP packet whose encryption is judged as being necessary by the decision to apply capsulation processing 2901, adds a suitable header to generate an IP sec tunnel model form packet and forwards it to the WAN side through the IP termination/address translation/forwarding processing 2911. When the encryption communication line necessary for this encryption processing has not yet been established, the start of the encryption communication is requested to the signaling processing 2904, and encryption and sending of the packet are carried out after the encryption communication line is established.

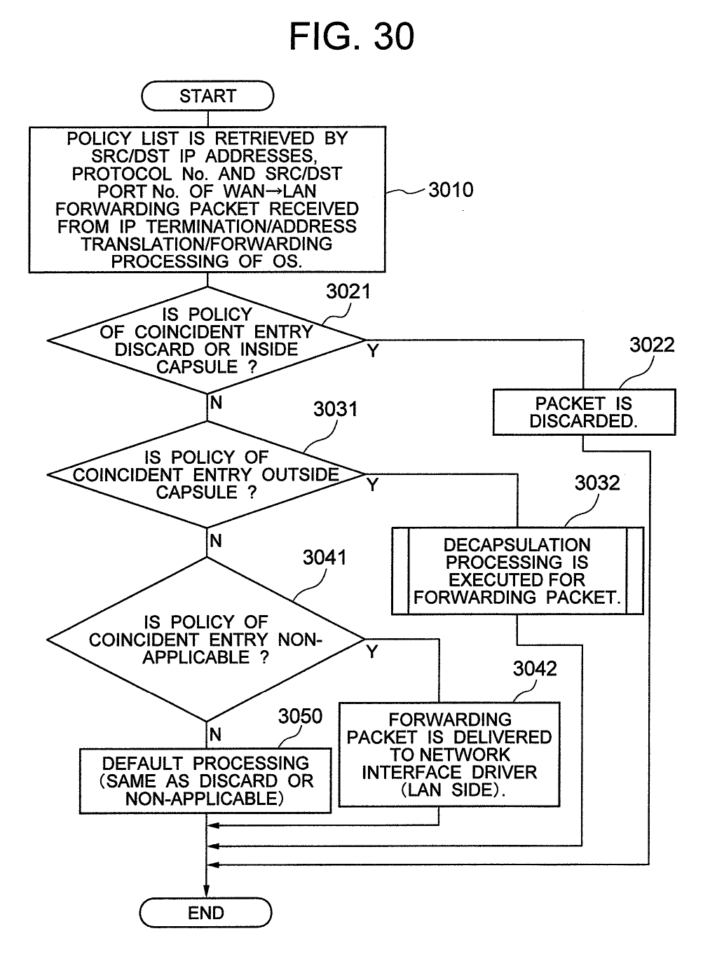

FIG. 30 is a flowchart showing the flow of the decision to apply encapsulation processing that is executed when the encryption communication module having the communication method of the invention receives the transmission packet from the IP processing of the OS in the second embodiment.

This algorithm is executed when the decision to apply encapsulation processing 2901 inside the encryption communication module 2700 receives the forwarding packet from the IP termination/address translation/forwarding processing 2911 of the LAN.

Receiving the forwarding packet to the LAN from the IP termination/address translation/forwarding processing 2911, the decision to apply encapsulation processing 2901 retrieves the policy list 102 in the same way as step 2310 in FIG. 23 (step 3010).

When the coincident entry is found out and the policy 550 of the entry is discarded or inside the capsule (step 3021), the forwarding packet is discarded (step 3022) and the processing is finished.

When the coincident entry is found out and the policy 550 of the entry is outside the capsule (step 3031), the decapsulation processing 2902 is executed for the forwarding packet (step 3032) and the processing is finished. When the coincident entry is found out and the policy 550 of the entry is not applicable (step 3041), the forwarding packet is handed over to the network interface driver (LAN side) 2921 (step 3042) and the processing is finished.

When the coincident entry is not found out, a processing that is the same as the discard or non-application processing is executed as a default processing (step 3050) and the processing is finished. Which of the discard and non-application processing should be employed as the default processing is different depending on which security policy the system is to be operated.

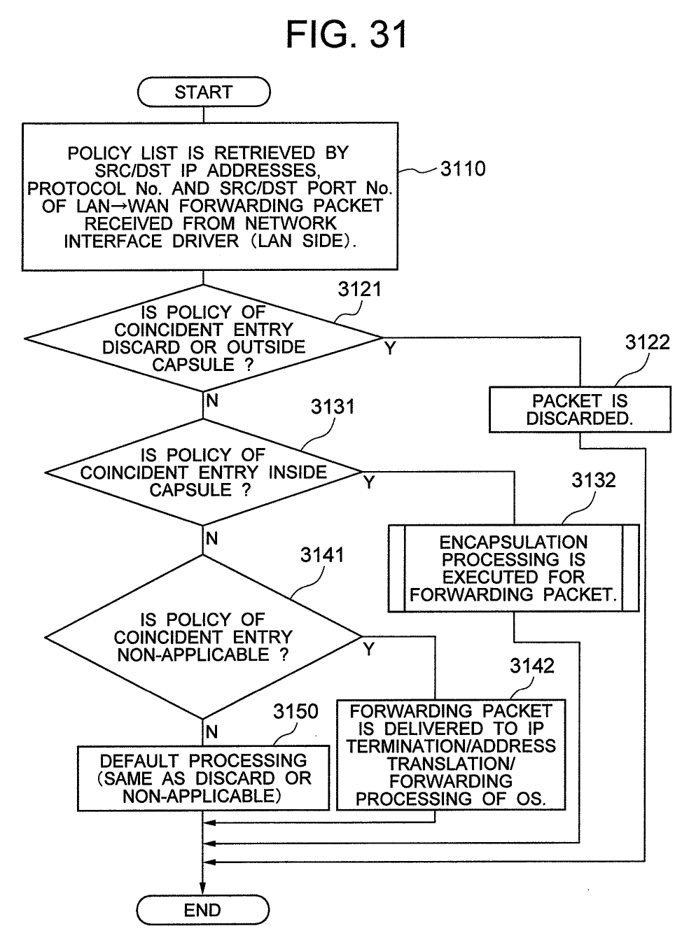

FIG. 31 is a flowchart showing the flow of the decision to apply encapsulation processing that is executed when the encryption communication module having the communication method of the invention receives the forwarding packet from the network interface driver (LAN side) in the second embodiment.

This algorithm is executed when the decision to apply encapsulation processing 2901 inside the encryption communication module 2700 receives the forwarding packet to the WAN from the network interface driver (LAN side).

Receiving the forwarding packet to the WAN from the network interface driver (LAN side) 2921, the decision to apply encapsulation processing 2901 retrieves the policy list 102 in the same way as step 2410 in FIG. 24 (step 3110).

In consequence, when the coincident entry is found out and the policy 550 of the entry is discarded or outside the capsule (step 3121), the forwarding packet is discarded (step 3122) and the processing is finished.

When the coincident entry is found out and the policy 550 of the entry is inside the capsule (step 3131), the encapsulation processing 2903 is executed for the forwarding packet (step 3132) and the processing is finished.

When the coincident entry is found out and the policy 550 of the entry is not applicable (step 3141), the forwarding packet is handed over to the IP termination/address translation/forwarding processing (step 3142) and the processing is finished.

When the coincident entry is not found out, a processing that is the same as the discard or non-application processing is executed as a default processing (step 3150) and the processing is finished. Which of the discard and non-application processing should be employed as the default processing is different depending on which security policy the system is to be operated.

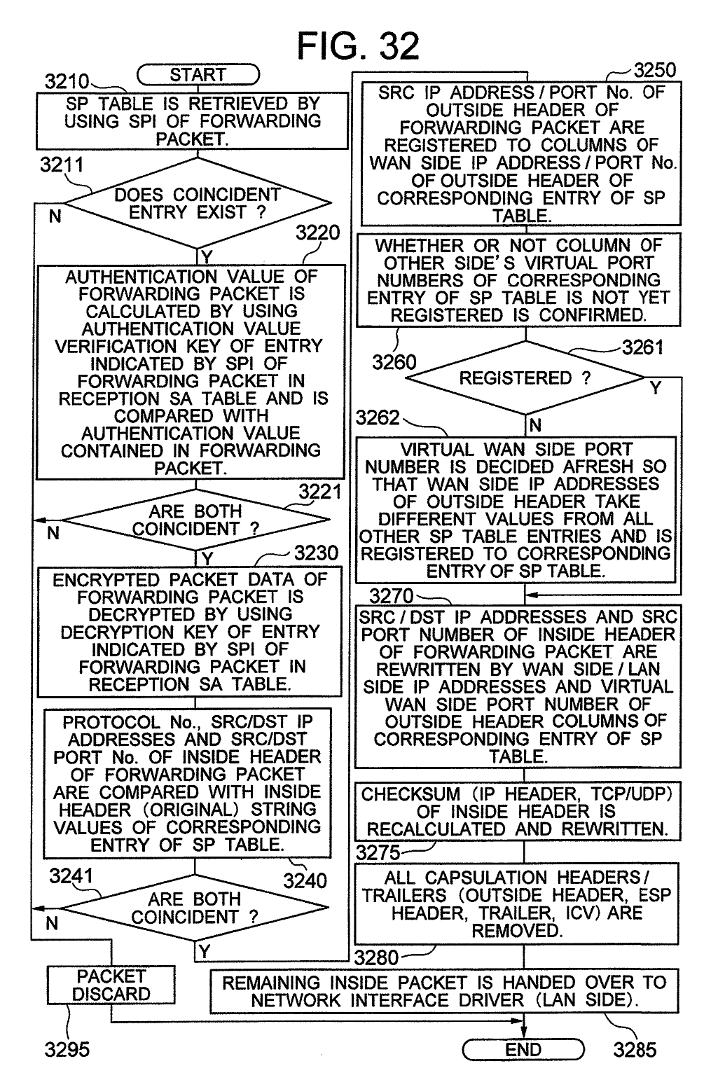

FIG. 32 is a flowchart showing the flow of the decapsulation processing of the forwarding packet that is called by the decision to apply capsulation processing of the encryption communication module having the communication method of the invention in the second embodiment.

The content of this flow is substantially the same as the flow of the decapsulation processing shown in FIG. 25 in the first embodiment. The great differences reside in that since the reception of the encrypted IPsec packet as the object of processing is made under the IP termination/address translation/forwarding processing 2911 but not on the UDP processing, the outside IP header and the outside UDP header are added to the encrypted IPsec before the processing and that the destination of the plain text IP packet finally created is the network interface driver (LAN side) 2921.

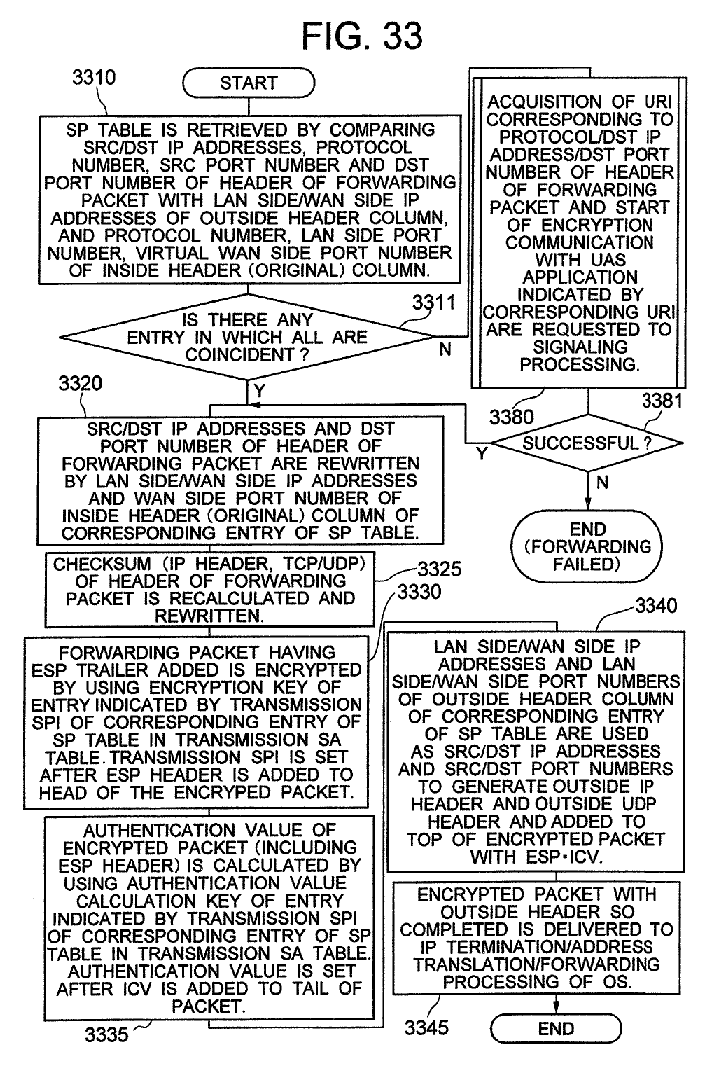

FIG. 33 is a flowchart showing the flow of the encapsulation processing that is called by the decision to apply encapsulation processing of the encryption communication module having the communication method of the invention in the second embodiment.

The content of this flow is substantially the same as the flow of the encapsulation processing shown in FIG. 26 in the first embodiment. The great differences reside in that since the delivery of the encrypted IPsec packet after processing is made to the IP termination/address translation/forwarding processing 2911 but not to the UDP processing, the outside IP header and the outside UDP header must be added to the encrypted IPsec after processing (STEP 3340) and that the destination of delivery of the encrypted IPsec packet finally created is the IP termination/address translation/forwarding processing 2911 (STEP 3345).

When the encryption communication module is arranged in the NAPT router as in this embodiment, the user terminal and the service providing server can conduct encryption communication even when they do not include therein the encryption communication module in the external network zone. Particularly when a plurality of user terminals (or service providing servers) is arranged under one NAPT router, the construction of this embodiment does not need the introduction of the encryption communication module for each user terminal (for each service providing server) although the construction of the first embodiment needs such introduction. Instead, since the communication between the user terminal (service providing server) and the NAPT router is plain text communication in this embodiment, security of communication must be secured for this zone by means different from that of the invention.

### Third Embodiment

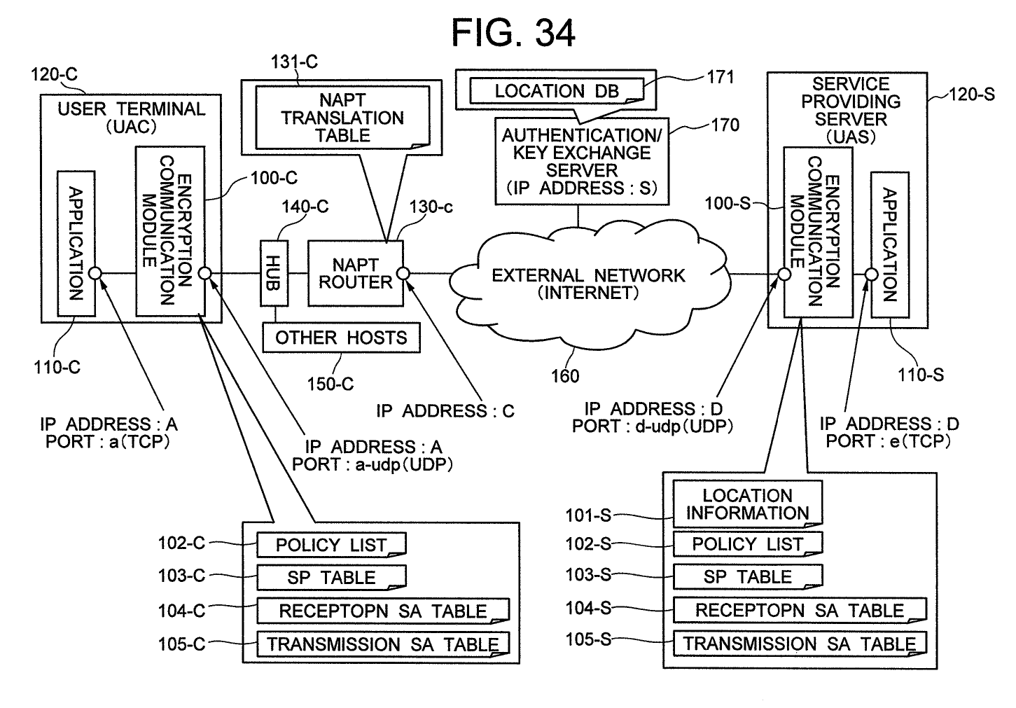

FIG. 34 shows a network construction of a system as an application object of the encryption communication module having the communication method of the invention in a third embodiment.

In the case where the NAPT is applied to only the user terminal side and the global IP address is directly allocated to the service providing server as in this embodiment, too, encryption communication of the application can be executed without any problem. In this embodiment, the encryption communication modules are built in the user terminal and the service providing server but the encryption communication module on the user terminal side may be built in the NAPT router without any problem as in the second embodiment.

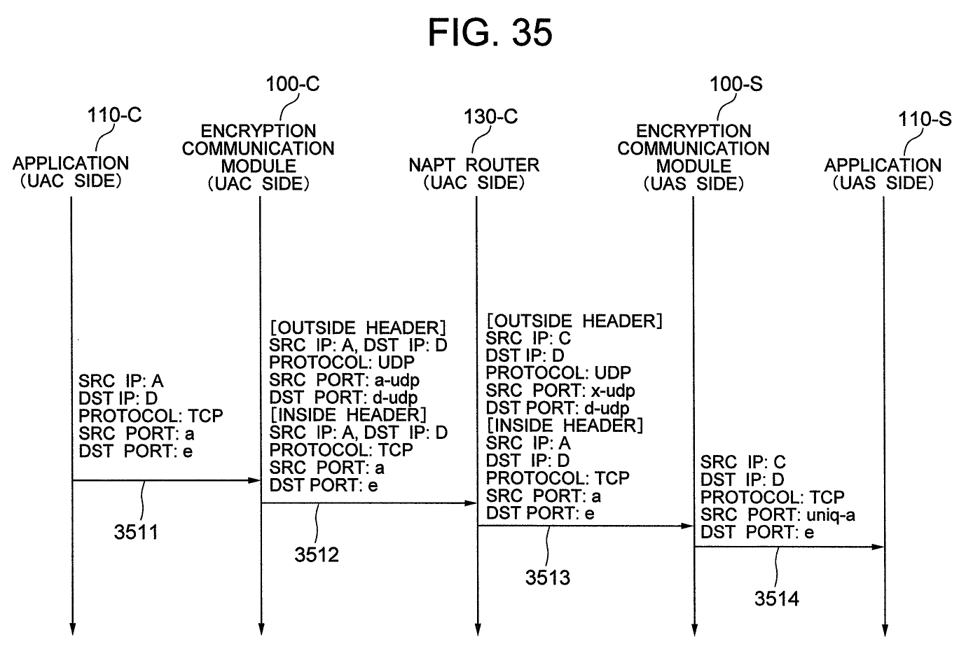

FIG. 35 is a sending/receiving sequence diagram for sending a data packet from a UAC side application to a UAS side application by using an encryption communication line when the encryption communication line is established between the UAC and UAS.

Since the NAPT router is not deployed on the service providing side in this embodiment, the IP address on the service providing server side and the outside UDP number are recognized by the same global IP address and the same port number (IP address D and port number d-udp in FIG. 34) in any apparatus and software. The rest are the same as the sequence diagram shown in FIG. 13 in the first embodiment.

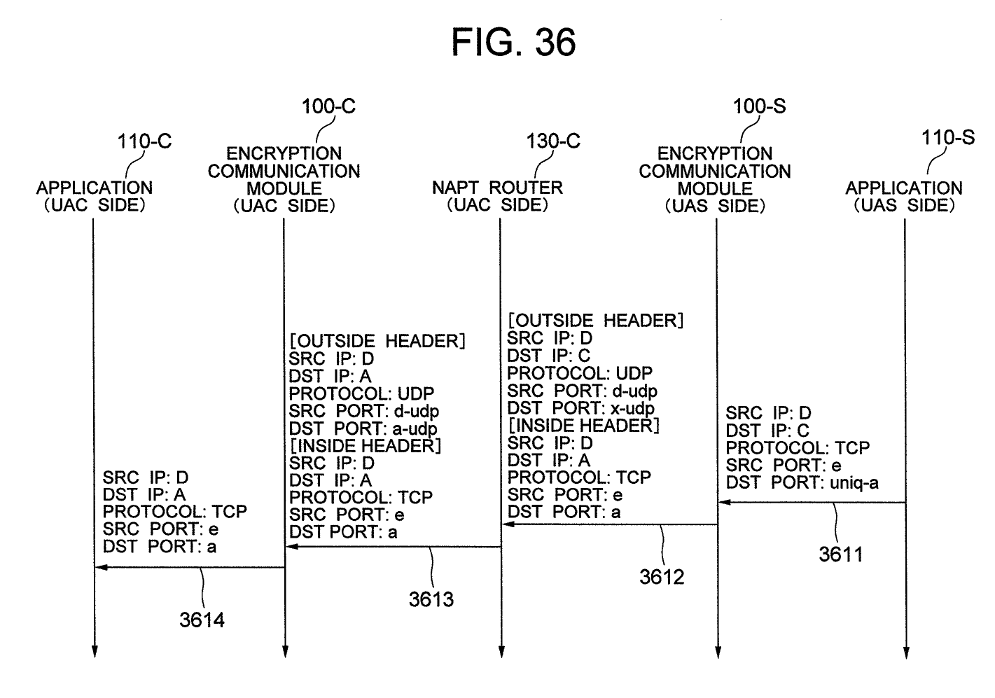

FIG. 36 is a sending/receiving sequence diagram for sending a data packet from a UAS side application to a UAC side application by using an encryption communication line when the encryption communication line is established between the UAC and UAS.

Since the NAPT router is not deployed on the service providing side in this embodiment, the IP address on the service providing server side and the outside UDP number are recognized by the same global IP address and the same port number (IP address D and port number d-udp in FIG. 34) in any apparatus and software. The rest are the same as the sequence diagram shown in FIG. 14 in the first embodiment.

### Fourth Embodiment

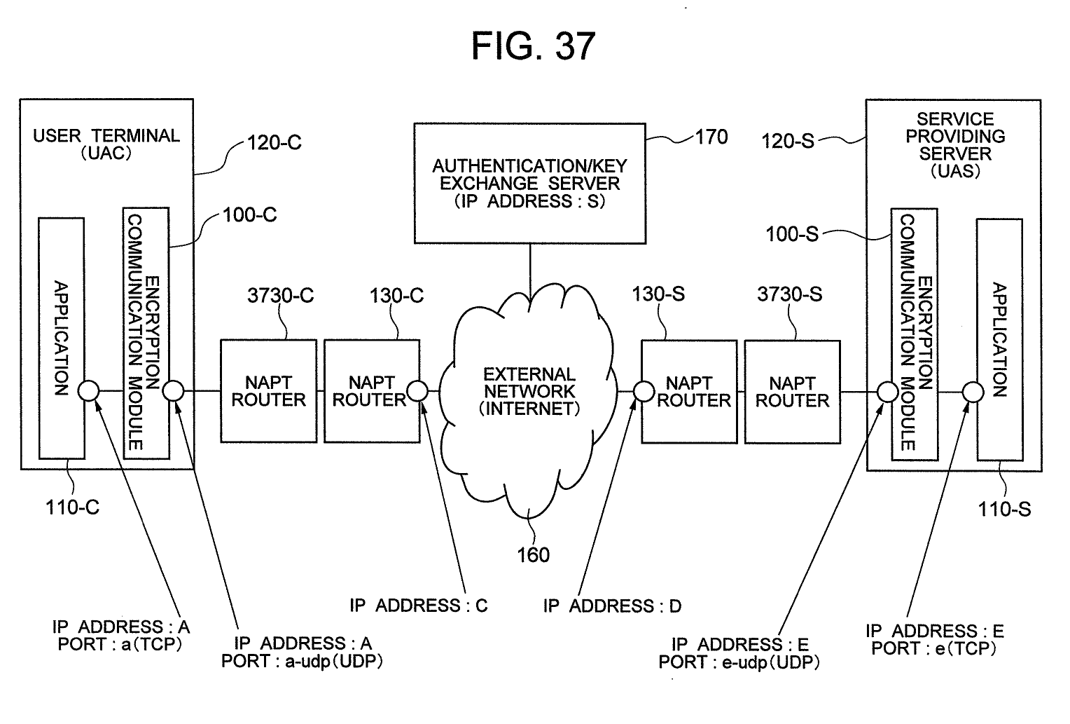

FIG. 37 shows a network construction of a system as an application object of the encryption communication module having the communication method of the invention in the fourth embodiment.

In the case where the NAPT routers are deployed double on the user terminal side as in this embodiment, too, encryption communication of the application can be executed without any problem. When the NAPT routers are deployed double on the service providing server side, too, encryption communication of the application can be executed without any problem by grasping in advance the global address allocated to the NAPT router positioned closest to the outside network 160 and the rule of the static NAPT translation occurring at the time of passage through both NAPT routers and making correctly setting to the encryption communication module on the service providing server side.

It should be further understood by those skilled in the art that although the foregoing description has been made on embodiments of the invention, the invention is not limited thereto and various changes and modifications may be made without departing from the spirit of the invention and the scope of the appended claims.

1. A network system including a first computer, a second computer and a first packet forwarding apparatus, each of which has a communication interface and is connected through a network:
wherein individual network addresses are allocated to said communication interfaces of said first and second computers;
said first computer has a first software operating on said first computer and said second computer has a second software operating on said second computer;
each of said first software and said second software executes communication by using a communication packet containing a network address representing a communication interface of a source computer, a network address representing a communication interface of a destination computer, an identifier representing a source software and an identifier representing a destination software;
said first computer has a first encryption/decryption processing unit or is connected to said first encryption/decryption processing unit and said second computer has a second encryption/decryption processing unit or is connected to said second encryption/decryption processing unit;
said first encryption/decryption processing unit encrypts the entire communication packet sent by said first software to said second software, adds afresh a network address and an identifier representing a source and a destination of said communication packet, forwards said communication packet, removes a network address and an identifier representing a source and a destination from the communication packet sent by said second software to said first software and decrypts the remaining part, and forwards said communication packet;
said second encryption/decryption processing unit encrypts the entire communication packet sent by said second software to said first software, adds afresh a network address and an identifier representing a source and a destination of said communication packet, forwards said communication packet, removes a network address and an identifier representing a source and a destination from the communication packet sent by said first software to said second software and decrypts the remaining part, and forwards said communication packet;
a network address is further allocated to said communication interface of said first packet forwarding apparatus;
said first packet forwarding apparatus translates the network address representing the communication interface of said first computer and the identifier representing said first software as the source of said communication packet and added afresh by said first encryption/decryption processing unit in the communication packet sent by said first software to said second software into a network address of the communication interface of said first packet forwarding apparatus and into an identifier arbitrarily allocate by said first packet forwarding apparatus and forwards said communication packet; and further translates the network address of the communication interface of said first packet forwarding apparatus and the identifier allocated arbitrarily as a destination of said communication packet added afresh by said second encryption/decryption processing unit to the communication packet sent by said second software to said first packet forwarding apparatus into a network address representing the communication interface of said first computer and into an identifier representing said first software, and forwards said communication packet;
when removing said network address and said identifier representing the source and the destination added by said first encryption/decryption processing unit and translated by said first packet forwarding apparatus from the communication packet sent by said first software to said second software and decrypting the remaining part, said second encryption/decryption processing unit replaces the network address of the source contained in said communication packet after decryption by the source network address added by said first encryption/decryption processing unit to said communication packet before decryption and translated by said first packet forwarding apparatus, allocates a unique value different from other communications having the same source network address as a new identifier and replaces the source identifier contained in said communication packet after decryption by said new identifier; and
a replacing rule of said network address and said identifier is stored, and is applied in a reverse direction to the source network address and the identifier of the communication packet sent from said second software to said first software.

2. A network system according to claim 1, which further includes a second packet forwarding apparatus interposed between said first packet forwarding apparatus and said second computer, a communication interface of said second packet forwarding apparatus having a network address allocated thereto, wherein:
said second packet forwarding apparatus translates the network address of the communication interface of said second packet forwarding apparatus and an identifier set in advance inside said second packet forwarding apparatus as the destination of said communication packet to a network address representing said second computer and an identifier representing said second software, respectively, in the communication packet sent by said first software to said second software, forwards said communication packet, translates the source of the communication packet to the network address of the communication interface of said second packet forwarding apparatus and the identifier set in advance for the communication packet sent from said second software to said first packet forwarding apparatus, and forwards the communication packet;
when removing said network address and said identifier representing the source and the destination added by said first encryption/decryption processing unit and translated by said first packet forwarding apparatus and said second packet forwarding apparatus for the communication packet sent by said first software to said second software and decrypting the remaining part, said second encryption/decryption processing unit replaces the network address of the destination contained in said communication packet after decryption by the destination network address added by said first encryption/decryption processing unit to said communication packet before decryption and translated by said first packet forwarding apparatus and said second packet forwarding apparatus.

3. A network system according to claim 2, which further includes a third computer connected to said network and used for mutual authentication of said first and second encryption/decryption processing units and exchange of key information and wherein:
said second encryption/decryption processing unit reports the network address of the communication interface of said second packet forwarding apparatus and the identifier set in advance to said second packet forwarding apparatus as a destination network address and a destination identifier of the communication packet to said first encryption/decryption processing unit through said third computer.

4. A network system according to claim 1, wherein said first packet forwarding apparatus, said second packet forwarding apparatus and said second encryption/decryption processing unit translate or replace a source or destination network address or an identifier contained in the communication packet and then recalculate appropriately an error detection code contained in the communication packet.

5. A network system according to claim 1, wherein said an IP (Internet protocol) address is used for said network address and a port number of TCP (Transmission Control Protocol) or UDP (User Datagram Protocol) is used for said identifier.

6. A network system according to claim 5, wherein IPsec (IP Security Protocol) to which a UDP header is added is used for an encryption protocol of said communication packet.

7. A network system according to claim 5, wherein SIP (Session Initiation Protocol) or a protocol created by encrypting SIP by TLS (Transport Layer Security) is used for a protocol for the information exchange between said second encryption/decryption processing unit and said first encryption/decryption processing unit.
